(19) United States
(12) Patent Application Publication
(10) Pub. No.: US 2024/0305025 A1
(43) Pub. Date: Sep. 12, 2024

(54) EASILY MAINTAINABLE I/O CONNECTOR CONFIGURED FOR CABLE CONNECTION TO A MIDBOARD

(71) Applicant: Amphenol Corporation, Wallingford, CT (US)

(72) Inventors: Jordan Winey, Middletown, PA (US); Daniel Dillow, New Cumberland, PA (US)

(73) Assignee: Amphenol Corporation, Wallingford, CT (US)

(21) Appl. No.: 18/592,364

(22) Filed: Feb. 29, 2024

Related U.S. Application Data
(60) Provisional application No. 63/450,592, filed on Mar. 7, 2023.

(51) Int. Cl. H01R 12/72; H01R 12/70; H01R 12/75; H01R 13/502; H01R 43/20

(52) U.S. Cl. CPC H01R 12/722; H01R 12/7064; H01R 12/75; H01R 13/502; H01R 43/205

(57) ABSTRACT

An I/O connector assembly configured for making cabled connections to an interior portion of a printed circuit board for signals passing through the connector. The assembly may include a receptacle subassembly and a low-speed subassembly. The external mating interface of the connector may be provided by the receptacle subassembly. Some of the conductive elements within the receptacle subassembly may terminate cables while others may be coupled to the low-speed subassembly at an internal, separable interface. The low-speed subassembly may be mounted to a PCB, including through the use of solder, and cabled connections may be separately added or removed, enabling the low-speed subassembly to be mounted using heat that might damage the cables or using a semi-permanent mounting technology, such as pressfit that might be damaged if removed once or a few times. Yet, the cables and/or cable terminations may be attached or detached for repair or replacement multiple times.

### BACKGROUND

This patent application relates generally to interconnection systems, such as those including electrical connectors, used to interconnect electronic assemblies.

Electrical connectors are used in many electronic systems. It is generally easier and more cost effective to manufacture a system as separate electronic assemblies, such as printed circuit boards (PCBs), which may be joined together with electrical connectors. A known arrangement for joining several printed circuit boards is to have one printed circuit board serve as a backplane. Other printed circuit boards, called “daughterboards” or “daughtercards,” may be connected through the backplane.

A backplane is a printed circuit board onto which many connectors may be mounted. Conducting traces in the backplane may be electrically connected to signal conductors in the connectors so that signals may be routed between the connectors. Daughtercards may also have connectors mounted thereon. The connectors mounted on a daughtercard may be plugged into the connectors mounted on the backplane. In this way, signals may be routed among the daughtercards through the backplane. The daughtercards may plug into the backplane at a right angle. The connectors used for these applications may therefore include a right-angle bend and are often called “right angle connectors.”

Connectors may also be used in other configurations for interconnecting printed circuit boards. Sometimes, one or more smaller printed circuit boards may be connected to another larger printed circuit board. In such a configuration, the larger printed circuit board may be called a “motherboard” and the printed circuit boards connected to it may be called daughterboards. Also, boards of the same size or similar sizes may sometimes be aligned in parallel. Connectors used in these applications are often called “stacking connectors” or “mezzanine connectors.”

Connectors may also be used to enable signals to be routed to or from an electronic device. A connector, called an “input/output (I/O) connector” may be mounted to a printed circuit board, usually at an edge of the printed circuit board. That connector may be configured to receive a plug at one end of a cable assembly, such that the cable is connected to the printed circuit board through the I/O connector. The other end of the cable assembly may be connected to another electronic device.

Cables have also been used to make connections within the same electronic device. The cables may be used to route signals from an I/O connector to a processor or other high speed components that are mounted in a midboard portion of a printed circuit board, away from the edge at which the I/O connector is mounted, for example. Cables provide signal paths with high signal integrity, particularly for high frequency signals, such as those above 40 Gbps using an NRZ protocol.

Each cable may have one or more signal conductors embedded in a dielectric and wrapped by a conductive foil. A protective jacket, often made of plastic, may surround these components. Additionally, the jacket or other portions of the cable may include fibers or other structures for mechanical support. One type of cable, referred to as a “twinax cable,” is constructed to support transmission of a differential signal and has a balanced pair of signal wires embedded in a dielectric and wrapped by a conductive layer. The conductive layer is usually formed using foil, such as aluminized Mylar.

### SUMMARY

In some aspects, a connector mounted to a printed circuit board and terminating cables is described.

Concepts as described herein may be embodied as an electrical connector configured for mounting to a printed circuit board and comprising a first mating interface configured for mating the electrical connector to a mating component. The electrical connector may comprise a first subassembly comprising a first housing, and a first plurality of conductive elements held by the first housing, each of the first plurality of conductive elements comprising a tail configured for connection to a printed circuit board and a mating contact portion. The electrical connector may comprise a second subassembly, configured to be separably coupled to the first subassembly at a second mating interface. The second subassembly may comprise a second housing; a second plurality of conductive elements supported by the second housing, the second plurality of conductive elements comprising conductive elements of a first type and conductive elements of a second type. Each of the second plurality of conductive elements may comprise a contact portion exposed at the first mating interface. Each of the first type of conductive elements of the second plurality of conductive elements may comprise a mating end portion configured to mate with a mating contact portion of a respective conductive element of the first plurality of conductive elements at the second mating interface. Each of the second type of conductive elements of the second plurality of conductive elements may comprise a tail portion configured for cable termination.

In another aspect, concepts as described herein may be embodied as an electrical connector, comprising a first subassembly. The first subassembly may comprise a first housing, and a first plurality of conductive elements held by the first housing and configured to be mounted to a printed circuit board. The electrical connector may also comprise a second subassembly, configured to be separably coupled to the first subassembly. The second subassembly may comprise a second housing and a second plurality of conductive elements supported by the second housing, having conductive elements of a first type and a second type. Conductive elements of the first type may have mating end portions configured for a separable electrical connection to the first plurality of conductive elements and conductive elements of the second type have tail portions configured for a cable termination.

In another aspect, concepts as described herein may be embodied as a method of assembling an electronic device. The method may comprise: mounting a first subassembly of an electrical connector to a printed circuit board at a first location, the first subassembly comprising a plurality of electrical conductors each comprising a tail, the mounting comprising mechanically and electrically connecting the tails of the plurality of electrical conductors to the printed circuit board; and coupling a second subassembly to the first subassembly; coupling the second subassembly to the first subassembly comprises electrically connecting a plurality of conductive elements of a first type in the second subassembly to the first plurality of electrical conductors of the first subassembly; and connecting a plurality of cables of the second subassembly to the printed circuit board at a second location, different than the first location.

In another aspect, concepts as described herein may be embodied as an electrical connector configured for mounting to a printed circuit board and comprising a first mating interface configured for mating the electrical connector to a mating component. The electrical connector may comprise a first subassembly comprising a first housing, and a first plurality of conductive elements held by the first housing, each of the first plurality of conductive elements comprising a tail configured for connection to a printed circuit board and a mating contact portion. The electrical connector also may comprise a second subassembly, configured to be separably coupled to the first subassembly at a second mating interface. The second subassembly may comprise a subassembly housing and a plurality of terminal subassemblies coupled to the subassembly housing. The plurality of terminal subassemblies may comprise a second plurality of conductive elements comprising conductive elements of a first type and conductive elements of a second type and a plurality of terminal subassembly housings, each of the plurality of terminal subassemblies comprising a respective terminal subassembly housing holding a subset of the plurality of the second plurality of conductive elements. Each of the second plurality of conductive elements may comprise a contact portion exposed at the first mating interface. Each of the first type of conductive elements of the second plurality of conductive elements may comprise a mating end portion configured to mate with a mating contact portion of a respective conductive element of the first plurality of conductive elements at the second mating interface. Each of the second type of conductive elements of the second plurality of conductive elements may comprise a tail portion configured for cable termination.

The foregoing features may be used separately or in any suitable combination. The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an isometric view of an illustrative electronic system in which a cabled connection is made between a connector mounted at the edge of a printed circuit board and a midboard cable termination assembly disposed on a printed circuit board.

FIG. 2A is a front isometric view of a receptacle connector, according to embodiments described herein;

FIG. 2B is a rear isometric view of the receptacle connector of FIG. 2A;

FIG. 2C is a rear isometric view of the receptacle connector of FIG. 2A contained within a cage;

FIG. 3A is an exploded front, side view from above of a receptacle connector of FIG. 2A;

FIG. 3B is an exploded bottom, side view from below of the receptacle connector of FIG. 2A;

FIG. 3C is an exploded rear, side view of the receptacle connector of FIG. 2A;

FIG. 4A is a front isometric view of a housing of a receptacle subassembly of the receptacle connector of FIG. 2A;

FIG. 4B is a rear isometric view of the housing of FIG. 4A;

FIG. 5A is a front, side isometric view from above of terminal subassemblies of the receptacle subassembly of FIG. 3A;

FIG. 5B is a side view of the terminal subassemblies of FIG. 5A;

FIG. 5C is a top, plan view of the terminal subassemblies of FIG. 5A;

FIG. 5D is a bottom plan view of the terminal subassemblies of FIG. 5A;

FIG. 6 is a front, side isometric view from above of a lower terminal subassembly of FIG. 5A;

FIG. 7A is front, side isometric view from above of an upper terminal subassembly of FIG. 5A;

FIG. 7B is a side view of the upper terminal subassembly of FIG. 6A;

FIG. 7C is a bottom plan view of the terminal subassembly of FIG. 6A;

FIG. 8 is a rear, side isometric view from above of a cage of FIG. 2C;

FIG. 9A is a view of receptacle connector components before assembly;

FIG. 9B is a side view illustrating a step in the process of assembling a receptacle connector;

FIG. 9C is a side view of an assembled receptacle connector;

FIG. 9D is a rear, side isometric view of an assembled receptacle connector;

FIG. 9E is a side view illustrating a step in the process of disassembling a receptacle connector assembly;

FIG. 10A is a view of receptacle connector components, including a cage before assembly;

FIG. 10B is a side view illustrating a step in the process of assembling a receptacle connector within a cage;

FIG. 10C is a side view of an assembled receptacle connector within a cage;

FIG. 10D is a rear, side isometric view of an assembled receptacle connector within a cage;

FIG. 10E is a side view illustrating a step in the process of removing a receptacle connector assembly from a cage;

FIGS. 11A and 11B are schematic illustrations of separably connecting a first subassembly of a connector to a second subassembly, according to some alternative embodiments of a connector described herein;

FIGS. 12A and 12B are schematic illustrations of separably connecting a first subassembly of a connector to a second subassembly, according to some alternative embodiments of a connector described herein;

FIGS. 13A and 13B are schematic illustrations of separably connecting a first subassembly of a connector to a second subassembly, according to some alternative embodiments of a connector described herein.

### DESCRIPTION OF PREFERRED EMBODIMENTS

The inventors have recognized and appreciated techniques that simplify reliable construction and maintenance of electronic systems with high signal integrity electrical connections from locations outside an electronic system to locations at the interior of a printed circuit board inside the system. Such connections may be made through an input/output (I/O) connector configured to receive a plug, which may be part of an active optical cable (AOC) assembly, a transceiver terminating a copper cable or a part of another interconnect. That connector may make connections to a printed circuit board to which the connector is mounted as well as to cables that may route signals from the I/O connector to other locations on that printed circuit board or elsewhere within the electronic system.

The inventors have recognized and appreciated connector designs that enable such connections while reducing reliability risks that might otherwise arise from the use of internal cables. Connectors according to these designs may include features that enable simple installation, removal and/or replacement of cables making connections between the connector and an internal location on a printed circuit board. Techniques as described herein may facilitate both high-speed and low speed connections being made with high signal integrity, and in a reliable and low-cost way. Low-speed signals, for example, may be connected to a PCB near the connector, such that they may be routed through the PCB to other locations in the electronic system. High-speed signals may be coupled to cables, which may be routed to a midboard region of the PCB or elsewhere in the electronic system remote from the where the connector is mounted.

These techniques may be implemented in a connector including two or more subassemblies. A first subassembly may include conductive elements that are connected to a printed circuit board. Conductive elements in a second subassembly may provide all or part of an external mating interface of the connector. Cables may be terminated to a subset of these conductive elements, enabling routing of high-speed signals through the cables. Others of the conductive elements in the second subassembly may make separable connections to conductive elements of the first subassembly, enabling connections within the connector to the PCB. Such connections may enable low-speed signals to be routed to the PCB, without passing through a cable.

The separable connections between conductive elements in the first subassembly and the second subassembly may be formed using pressure contacts. Pressure contacts, for example, may be provided with mating end portions of the conductive elements in one subassembly configured as compliant beams pressed against mating contact portions of conductive element of another subassembly configured as pads. The force to press the subassemblies together may be provided by a member, such as a clip and/or other member, such as a cage enclosing at least portions of the first and second subassemblies. Alternatively or additionally, a clip or other member connecting subassemblies may include conductive elements that make contact with conductive elements in each of the subassemblies, thereby connecting them.

With such a connector, an electronic device may be simply manufactured or repaired. For example, the first subassembly of an electrical connector may be mounted to a PCB. Optionally, a cage may be mounted to the PCB and at least a portion of the first subassembly may be within the cage. The second subassembly of the connector may be mated to the first subassembly via separable connections. The second subassembly may include conductive elements that terminate cables and others that mate to the conductive elements of the first subassembly for connection to the PCB through the first subassembly. In some examples, both conductive elements of the second subassembly terminated to cables and those configured for mating to the first subassembly may include contact portions exposed at a mating interface of the connector.

In use, the second subassembly, including cabled connections to the midboard, may be separately manufactured and then easily integrated into a connector. If the integrity of signals carried on the cabled connections degrades, the second subassembly may be removed and repaired or replaced, without the need to rework the connections to the PCB. For example, repairs to the electronic system may be made without removing the first subassembly and/or the cage, if present.

Such a configuration may enable the connector and/or the cage to be mounted to a PCB with pressfits or other mounting technology that need not support easy removal. A pressfit, for example, is conventionally used for insertion into a hole in a PCB one time, such that, a connector removed after it is once mounted to a PCB is likely to be discarded rather than reused. Moreover, even if it is acceptable to discard each connector when removed, plated through holes in a PCB that receive pressfits are degraded each time a pressfit is inserted and can only withstand a small number of insertions before even a new connector with press fits does not make reliable connections to the PCB. With a connector configured as described herein, if it is desired to modify or repair cabled connections after a connector is installed, the second subassembly with cable terminations may be easily removed, leaving the connections to the PCB through the first subassembly in place. With a separable interface between the first subassembly and the second subassembly, the second subassembly may be removed, repaired, modified and/or replaced hundreds or thousands of times, without impacting the performance of the first subassembly and its mounting to the PCB.

Alternatively or additionally, the first subassembly may be mounted to the PCB with a mounting technique that requires solder reflow, such as surface mount soldering or BGA mounting. With a conventional design, the heat required for reflow might damage cables terminated to the connector, leading to a degradation of signal quality of high-speed signals carried over those cables. With techniques as described herein, the first subassembly may be attached to the PCB using solder, without the cables terminated to the second subassembly exposed to heat for mounting the first subassembly. These cables may be provided when the second subassembly is mated to the first subassembly, which may happen after the first subassembly is mounted to the PCB.

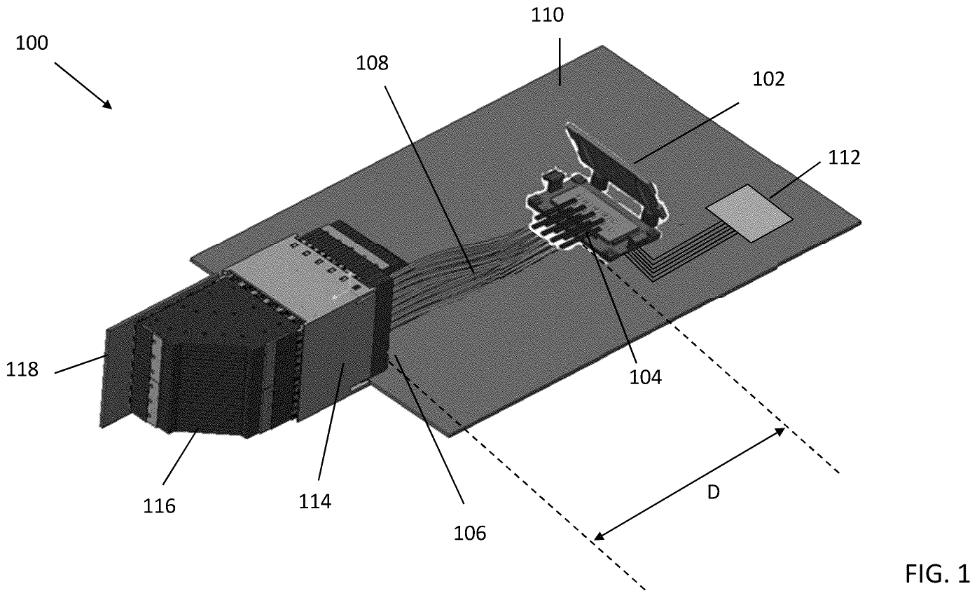

FIG. 1 is an isometric view of an illustrative electronic system 100 in which a cabled connection is made between a connector 114 mounted at the edge of a printed circuit board and a midboard cable termination assembly disposed on a printed circuit board. Connector 114 also makes connections to printed circuit board 110. One or more of the techniques for construction of a connector as described herein may be used in constructing connector 114.

In the illustrated example, cables 108 provide low loss paths for routing electrical signals between one or more components, such as component 112, mounted to printed circuit board 110 and a location off the printed circuit board. Component 112, for example, may be a processor or other integrated circuit chip. However, any suitable component or components on printed circuit board 110 may receive or generate the signals that pass through cables 108.

In the illustrated example, connector 114 couples signals between component 112 and printed circuit board 118. Printed circuit board 110 may be a motherboard, for example, and printed circuit board 118 may be a daughtercard. Printed circuit board 118 is shown to be orthogonal to printed circuit board 110. Such a configuration may occur in a telecommunications switch or in other types of electronic equipment. However, connectors as described herein may be used in electronic equipment with other architectures. For example, a connector may be used to couple signals between a location in the interior of a printed circuit board and a transceiver terminating an active optical cable assembly.

In the example of FIG. 1, connector 114 is mounted at the edge of printed circuit board 110. Rather than being configured as an I/O connector, connector 114 is configured to support connections between the orthogonal printed circuit boards 110 and 118. Nonetheless, FIG. 1 illustrates cabled connections for some of the signals passing through connector 114 and coupling through a printed circuit board 110 for others of the signals passing through connector 114. This technique may be similarly applied in an I/O connector, such as those described herein. Conversely, techniques as described herein in connection with an I/O connector may be applied to an orthogonal connector as illustrated in FIG. 1 or a connector of another configuration.

FIG. 1 shows a portion of an electronic system including midboard cable termination assembly 102, cables 108, component 112, right angle connector 114, connector 116, and printed circuit boards (PCBs) 110, 118. Midboard cable termination assembly 102 may be mounted on PCB 110 near component 112, which is also mounted on PCB 110, in this example. Midboard cable termination assembly 102 may be electrically connected to component 112 via traces in PCB 110. Other suitable connections techniques, however, may be used instead of or in addition to traces in a PCB. In other implementations, for example, midboard cable termination assembly 102 may be mounted to a component package containing a lead frame with multiple leads, such that signals may be coupled between midboard cable termination assembly 102 and the component through the leads. Alternatively or additionally, ends of cables 108 may be coupled to component 112 by terminating the cables to the component package directly or to a socket holding component 112.

Cables 108 may electrically connect midboard cable termination assembly 102 to a location remote from component 112 or otherwise remote from the location at which midboard cable termination assembly 102 is attached to PCB 110. In the example of FIG. 1, a second end of cable 108 is connected to right angle connector 114. Connector 114 is shown as an orthogonal connector that can make separable electrical connections to connector 116 mounted on a surface of printed circuit board 118 orthogonal to printed circuit board 110. Connector 114, however, may have any suitable function and configuration, and may, for example, be an I/O connector as described below. If configured as an I/O connector, connector 114 may be configured to mate with a transceiver terminating a copper of optical fiber cable.

In the example of FIG. 1, connector 114 includes one type of connector unit mounted to PCB 110 and another type of connector unit terminating cables 108. Such a configuration enables some signals routed through connector 114 to connector 116 to be connected to traces in PCB 110 and other signals to pass through cables 108. In some embodiments, higher frequency signals, such as signals above 130 GHz or above 25 GHz above 56 GHz or above 1312 GHz in some embodiments, may be connected through cables 108.

Cables 108 may have first ends 104 attached to midboard cable termination assembly 102 and second ends 106 attached to connector 114. Cables 108 may have a length that enables midboard cable termination assembly 102 to be spaced from second ends 106 at connector 114 by a distance D. The distance D may be longer than the distance over which signals at the frequencies passed through cables 108 could propagate along traces within PCB 110 with acceptable losses. In some embodiments, D may be at least six inches, in the range of one to 20 inches, or any value within the range, such as between six and 20 inches. However, the upper limit of the range may depend on the size of PCB 110, and the distance from midboard cable termination assembly 102 that components, such as component 112, are mounted to PCB 110. For example, component 112 may be a microchip or another high-speed component that receives or generates signals that pass through cables 108.

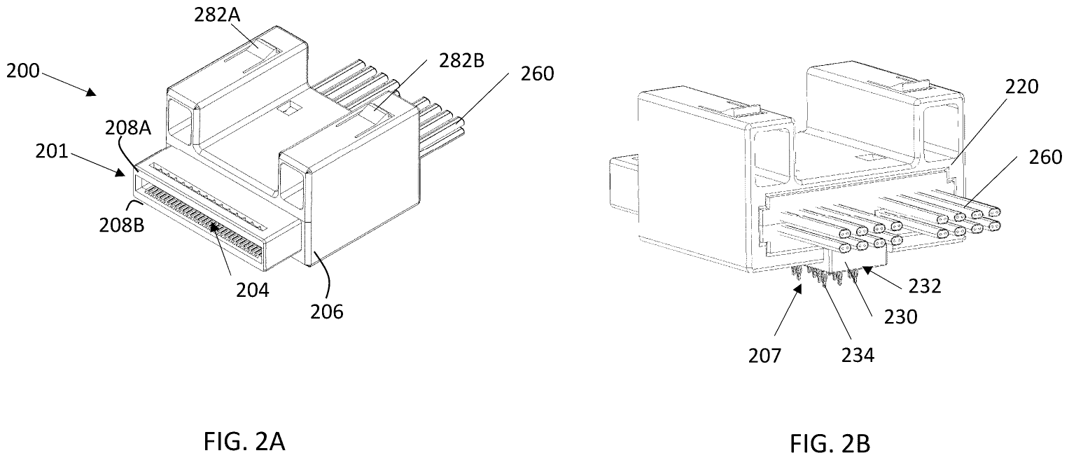

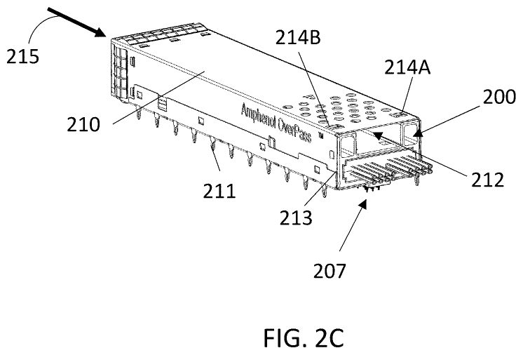

FIGS. 2A-10D illustrate design and assembly of a receptacle connector 200 that may be easily constructed and maintained while enabling both connections to a substrate, such as a PCB, to which the connector is mounted and cabled connections between a mating interface of the connector and locations within an electronic system remote from the connector. Connector 200 has multiple subassemblies, one of which may support connections to a printed circuit board and one of which support cabled connections. One of the subassemblies may provide a first mating interface for mating to complementary connector. The two subassemblies may mate at a second separable interface such that the first mating interface may be connected within the connector to tails of conductive elements of the first subassembly that are configured for mounting to the PCB and to tails of the second subassembly that are configured for terminating cables. In the illustrated example, enhanced high frequency performance is achieved with the conductive elements forming the first mating interface being in the second subassembly.

In the following description an I/O connector, configured as a receptacle, is used as an example of such a connector. The I/O connector may be mounted to an edge of the PCB and the remote location, to which cables are routed, may be a midboard region of that PCB where processors or other high-speed components are mounted.

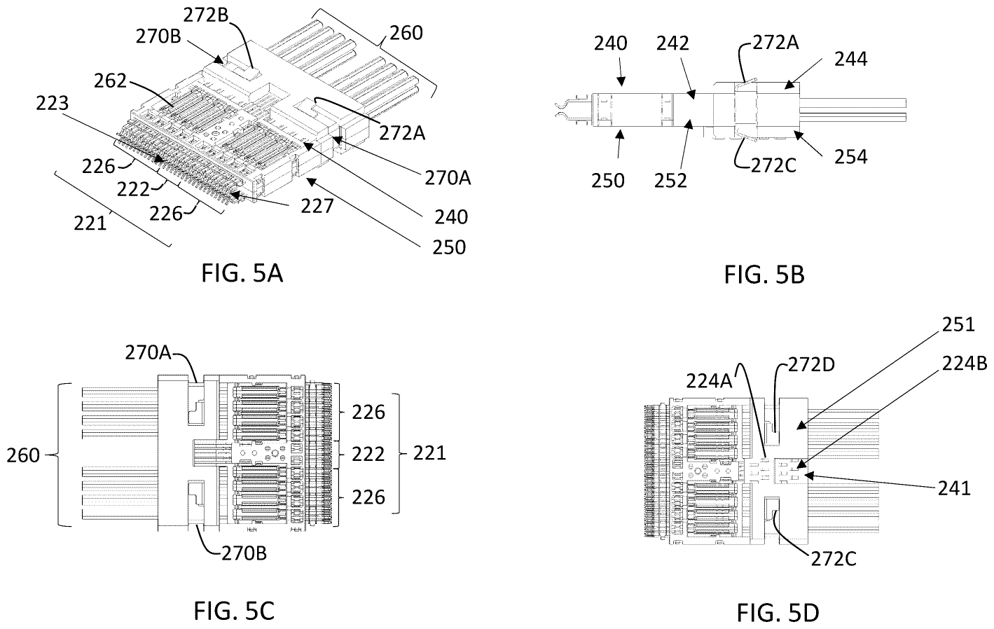

FIG. 2A illustrates a receptacle connector 200. In this example, receptacle connector 200 has a mating interface 201 on a front surface. The mating interface comprises a cavity 204 in a connector housing 206 configured to receive a mating component. In this example, cavity 204 is shaped as a slot, such as might receive the mating end of a paddle card of a plug. Connector housing 206 in this example is made from insulative material, such as may be formed by injection molding. Contact portions of conductive elements (e.g. conductive elements 221 of FIGS. 5A-D) may be exposed within cavity 204 such that a mating component inserted into cavity 204 engages contact portions of the conductive elements of the connector 200.

In FIG. 2B, a mounting interface 207 of the receptacle connector is visible. The mounting interface 207 includes tails 234 of conductive elements 232 of connector 200. Mounting interface 207 may be configured to mount to a printed circuit board. In this example, the mounting interface is planar, such that connector 200 may be mounted to a planar surface of a printed circuit board.

Also visible in FIGS. 2A and 2B are cables 260 extending from a rear portion of receptacle connector 200. The other end of those cables (not visible in FIG. 2A) may be connected to a location in an electronic device remote from where connector 200 is mounted. The other end of the cables, 260 may be terminated to a midboard cable termination assembly 102 as described above in connection with FIG. 1, or another connector, or a semiconductor chip package, for example, which is mounted in a midboard location of the same PCB to which connector 200 is mounted. Such a configuration enables electrical signals to be routed from the plug of a cable assembly to the midboard without passing through the printed circuit board.

Such a configuration enables high-speed signals to be routed through the cables with less distortion than if they had been routed through the PCB. In the embodiment illustrated, the cables 260 are coupled within connector 200 to conductive elements having contact portions at mating interface 201 of the connector 200 that mate to contact portions in a plug that also carry high-speed signals, such as signals having a fundamental frequency of 25 GHz or higher. As a specific example, the high-speed signals may be low voltage differential (LVDS) with PAM4 modulation at a bit rate of 56 Gbps or higher. Tails 234 are coupled to conductive elements having contact portions located at mating interface 201 of the connector 200 that mate to contact portions in a plug that carry low-speed signals. Such low-speed signals may be routed through a PCB with little distortion, even if the routing within the PCB extends over distances greater than 6 inches. As a specific example, the low-speed signals may be power or low-speed control signals for a communication channel.

In the illustrated example, cavity 204 has a first side 208A and a second, opposite side, 208B. Contact portions of the conductive elements within connector 200 line both first and second sides 208A and 208B. In this configuration, connector 200 may mate with a plug that has contact portions positioned in two parallel rows on opposite surfaces of a paddle card.

In the illustrated example, connector 200 is configured for low-speed signals routed through the contact portions in a central region of each of those rows and high-speed signals at end portions of those rows. Such a configuration may be the result of low-speed subassembly 230 being in the central portion of connector 200 with groups of cables 260 on either side. However, low-speed subassembly 230 may be in other locations with respect to the cables, such as to one side of the connector with the cables on the other.

Connector 200 may be used within a cage that may be mounted to the same PCB as connector 200. FIG. 2C illustrates receptacle connector 200 housed within a cage 210. Receptacle connector 200 and/or cage 210 may include engagement features that position and/or retain connector 200 within cage 210. In the example illustrated, connector 200 is positioned such that cables 260 extend through a rear of cage 210 and mounting interface 207 is exposed through a floor of cage 210. Mating interface 201 may be within a channel 212 of the cage. Channel 212 may guide a plug in mating direction 215 to connect with mating interface 201 of receptacle connector 200.

In this example, connector 200 comprises engagement features that may engage with complementary engagement features of the cage. These features may enable a separable engagement between connector 200 and cage 210, and may be, for example, depressible tabs or snap fit joints. In the illustrated example, engagement features on connector 200 are configured as beams 282A and 282B and complementary engagement features on cage 210 are configured as openings 214A and 214B, which are in a top surface of the cage. Beams 282A and 282B may be deflected, resulting in a connection is not permanent as the beams 282A and 282B may be depressed to disengage from openings 214A and 214B of the cage 210.

Connector 200 is formed from multiple subassemblies. In the example illustrated, conductive elements configured for terminating cables are in a separate subassembly from conductive elements with tails configured for mounting to a PCB. The subassemblies may be mated through a separable interface internal to the connector. In this way, a first subassembly may be mounted to a PCB and a second subassembly, with conductive elements terminated to cables, may be later mated to it and/or unmated from it. The full external mating interface of the connector may be contained within one subassembly as forming the mating interface as part of a subassembly may enable mechanical and/or electrical properties of the interface to be more precisely controlled, which in turn may increase integrity of signals routed through the connector.

In the illustrated example, the external mating interface is implemented in the second subassembly. With this configuration, high-speed signals at the mating interface may be coupled to cables through conductive elements within the second subassembly. Low-speed signals at the mating interface may be coupled to the PCB through conductive elements in the second subassembly and then to conductive elements within the first subassembly that have tails for PCB attachment through the internal mating interface between the second subassembly and the first subassembly. Having the full mating interface as part of the subassembly with conductive elements terminated to cables avoids the need for high-speed signals routed from the mating interface to the cables to pass through an internal mating interface between subassemblies, which might otherwise degrade integrity of high frequency signals. Low-speed signals are less susceptible to distortion at an internal mating interface, such that both flexibility and performance may be achieved.

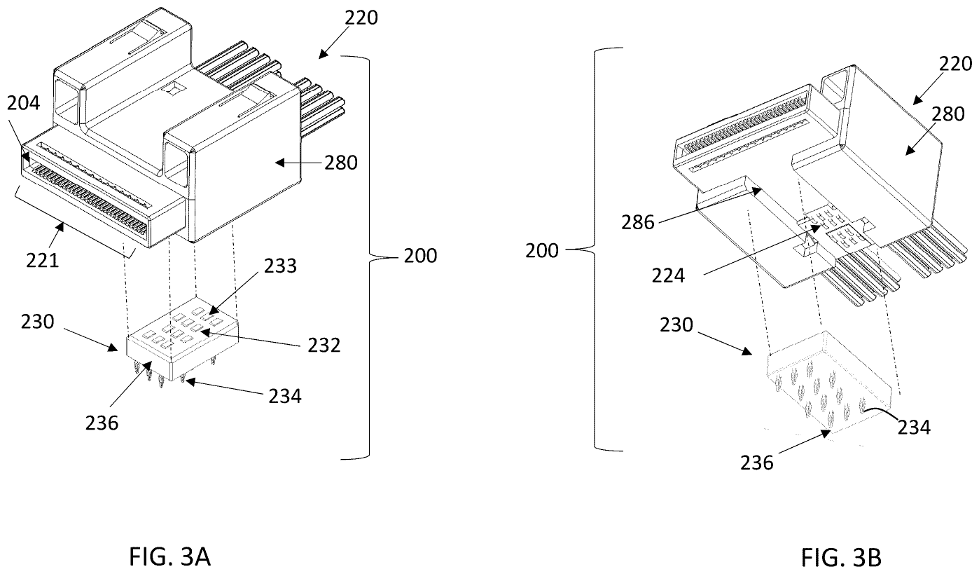

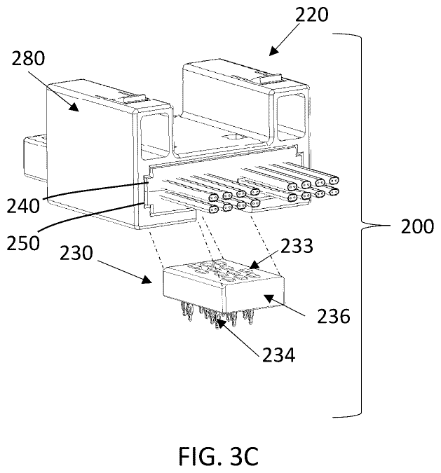

FIGS. 3A-3C are exploded views of receptacle connector 200. In this example, receptacle connector 200 is formed from two subassemblies, a receptacle subassembly 220 and a low-speed subassembly 230. Each of the subassemblies may have a subassembly housing and a plurality of conductive elements held within the housing. Receptacle subassembly 220, for example, has a housing 280, and low-speed subassembly 230 has a housing 236. The housings of the subassemblies maybe insulative and may be a portion of the housing for connector 200. In the illustrated example, housing 206 is formed by the combination of the housings of receptacle subassembly 220 and low-speed subassembly 230.

In an assembled state, the receptacle subassembly 220 and low-speed subassembly 230 are in electrical connection. In this example, conductive elements within receptacle subassembly 220 configured to carry low-speed signals are coupled to conductive elements in low-speed subassembly 230 through an internal mating interface. That mating interface may provide a separable connection between the subassemblies. One or more mechanisms may be used to align receptacle subassembly 220 and low-speed subassembly 230 for mating. Alternatively or additionally, one or more mechanisms may be used to generate a contact force at that mating interface.

In the illustrated example, receptacle subassembly 220 and low-speed subassembly 230 are nested, with low-speed subassembly 230 fitting within an opening, such as slot 286, in receptacle subassembly 220. Nesting of the subassemblies may aid in forming connections between subassembly 220 and low-speed subassembly 230. As visible in FIG. 3B, housing 280 of receptacle subassembly 220 comprises a slot 286 configured to receive at least a portion of low-speed subassembly 230 when assembled such that the two subassemblies are nested. In this example, an internal mating interface where conductive elements of receptacle subassembly 220 and low-speed subassembly 230 mate is within slot 286.

In this example, receptacle subassembly 220 has at least two types of conductive elements, a first type configured for mating with the second subassembly and a second type configured for terminating cables. All types of conductive elements may have a contact portion exposed at an external mating interface for the connector. The types of conductive elements may differ in the structure away from the contact portions.

The first type of conductive elements may be configured for low-speed signals and the second type may be configured for high-speed signals. Mating end portions 224 of conductive elements of a first type 222 of the plurality of conductive elements 221 of the receptacle subassembly 220 may be exposed at the internal interface between the first subassembly and the second subassembly, which in this example is within slot 286. The positioning of these mating end portions 224 in slot 286 is such that when the first subassembly and the second subassembly are assembled into a connector, the mating end portions 224 are in electrical contact with mating contact portions 233 of conductive elements 232 of low-speed subassembly 230.

Conductive elements 232 comprise mating contact portions 233 configured to electrically connect with mating end portions 224 of the first type of conductive elements 222 of the receptacle subassembly. A separable interface may be formed between receptacle subassembly 220 and low-speed subassembly 230 with pressure contacts. One or both of the mating end portions 224 and mating contact portions 233 may be compliant. The compliant elements may be deflected for mating so as to generate a contact force. In the illustrated example, mating end portions 224 are compliant beams and mating contact portions 233 are pads. Additionally or alternatively, mating contact portions 233 may be compliant beams.

In the illustrated example, conductive elements of low-speed subassembly 230 comprise intermediate portions that connect the mating contact portions 233 to the tails 234. The intermediate portions, for example, may be within housing 236. Such a structure may be formed, for example, by insert molding housing 236 around the intermediate portions or inserting the conductive elements into slots in housing 236 after housing 236 is formed by injection molding. In the illustrated example, tails 234 are pressfits, which can attach to a printed circuit board by pressing the low-speed subassembly 230 into plated holes in a printed circuit board with mechanical force.

Either or both of the subassemblies may be constructed of multiple components. As shown in FIG. 3C, receptacle subassembly 220 may include multiple terminal subassemblies. In this example, two terminal subassemblies 240 and 250 are illustrated. Terminal subassembly 240 includes conductive elements with contact portions that line side 208A of cavity 204 at the mating interface 201. Terminal subassembly 250 includes conductive elements with contact portions that line side 208B of cavity 204 at the mating interface 201.

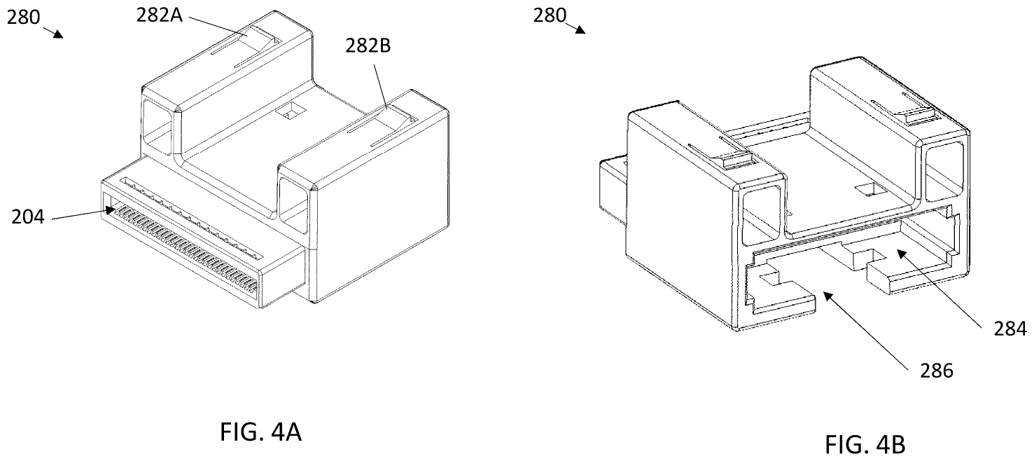

Receptacle subassembly 220 also includes housing 280, as shown in FIGS. 4A and 4B. In this example, housing 280 holds terminal subassemblies 240 and 250 and additionally comprises a slot 286 on a bottom face configured to receive at least a portion of low-speed subassembly 230 when connector 200 is assembled. Housing 280 includes cavity 284 (FIG. 4B), which is configured to support a plurality of terminal subassemblies, for example 240 and 250. In this example, cavity 204 containing mating interface 201 is formed within housing 280. When positioned in cavity 284, contact portions 223 and 227 of a respective first 222 and second 226 type of conductive elements of the plurality of conductive elements 221 of the receptacle subassembly 220 are exposed at mating interface 201. As shown, opposing sides 208A and 208B have channels into which the contact portions may be inserted such that they may deflect upon insertion of a paddle card or other mating structure into cavity 284.

FIGS. 5A-5D show terminal subassemblies 240 and 250 stacked side by side and configured for insertion into cavity 284. Both terminal subassemblies 240 and 250 include a plurality of conductive elements, of which conductive elements 221 of subassembly 250 are numbered. The conducive elements of a terminal subassembly may be held within an insulative overmold 242 and 252, respectively. For example, intermediate portions of the conductive elements 221 may be overmolded with an insulative material, such as plastic. The plastic holds the conductive elements 221 with their mating contact portions in a row. Both the contact portions and tails of the conductive elements may extend from the insulative material.

In the example illustrated, each terminal subassembly 240 and 250 provides one row of contact portions of the conductive elements. In the example of FIGS. 5A-5D, the contact portions of the conductive elements in each subassembly have the same shape. In other examples, however, a terminal subassembly may have contact portions of various shapes, such as wider contact portions for ground contacts or more closely spaced contact portions for pairs of signal conductors. In this example, the contact portions are shaped as compliant beams with a convex surface forming a contact surface. The contact surfaces for each subassembly face into cavity 204 such that the contact portions of subassembly 240, which are on the top side 208A, are oriented oppositely from the contact portions of subassembly 250, which are on the bottom side 208B.

Each of the terminal subassemblies may contain conductive elements of different types. In the embodiment illustrated, all types of conductive elements in the terminal assemblies have the same shaped contact portions but differ in the shape of the intermediate portions and/or tail portions. FIG. 5A, for example, is numbered to indicate a first type conductive element 222 and a second type conductive element 226 in terminal subassembly 250. In this example, terminal subassembly 240 also includes two types of conductive elements.

First type conductive elements 222 have mating end portions 224A configured for electrical attachment to mating contact portions 233 of the plurality of conductive elements 232 of the low-speed subassembly 230. The first type of conductive elements 222 may comprise intermediate portions bending through a 90-degree angle. With such a bend, mating end portions 224A may be exposed at a lower surface 251 of the terminal subassembly 250 and may be perpendicular to the contact portions 223 of the conductive elements 222. Conductive elements of the first type in terminal subassembly 240 similarly have mating end portions 224B configured for electrical attachment to mating contact portions 233 as shown in FIG. 5D. In this example, mating end portions 224A and 224B are compliant beams and extend through the respective surfaces 241 and 251. Those surfaces 241 and 251 may be planar and may be parallel, as illustrated in the example of FIG. 5D.

Conductive elements of the second type, of which second type conductive elements 226 of terminal subassembly 250 are numbered, have tail portions configured for terminating to cables. In the example illustrated, second type conductive elements terminate to cables 260. In this example, each of the cables 260 is a twinax cable having a pair of signal conductors and a shield surrounding the signal conductors. The second type conductive element may be configured in groups of conductive elements, with each group terminating one cable. A group of the second type conductive elements, for example, may have a pair of conductive elements aligned for connection to the pair of signal conductors in a cable. These conductive elements may serve as signal conductors within the connector. This pair of second type conductive elements may be next to an additional second type element, or in some examples, between two additional second type conductive elements that are positioned for connection to the shield of the cable. These additional second type conductive elements may serve as ground conductors within the connector.

The signal conductors of the cable may be connected to respective second type conductive elements via soldering, welding, or brazing, for example. The cable shields may be directly or indirectly connected to second type conductive elements. Indirect connections may be formed, for example, if the cables include drain wires, which may be attached to the second type conductive elements. In the embodiment illustrated, indirect connection is provided through a shield 262. Each of the terminal subassemblies may include a shield 262.

Shield 262 has flat portions, which may be welded or otherwise attached to the ground conductors on either side of the pairs of signal conductors. The shield has concave portions between the flat portions, which may partially encircle a cable 260 in a region where any outer insulative jacketing on the cable is removed to expose the shield. These concave portions may be sized to press against the cable shield, thereby making contact to the shield.

In the example illustrated, the concave portions of the shield extend over the locations where the signal conductors of the cable are fused to the signal conductors of the connector. These connections between the signal conductors of the cable and signal conductors of the connector are not visible in FIG. 5A because they are covered by a shield 262.

Mechanical support for the cables 260 may be provided with strain relief portions 244 and 254 which may be configured to support cables 260 terminated to terminal subassemblies 240 and 250, respectively. Strain relief portions 244 and 254 may be formed of the same material as the insulative overmolds 242 and 252 of the terminal subassemblies 240 and 250. Alternatively or additionally, different materials may be used. For example, the insulative material of the insulative overmolds 242 and 252 may be selected to have a suitable dielectric constant, such as greater than 3, while the material for the strain relief portions 244 and 254 may be selected for mechanical properties, such as flexibility and/or durability.

Structures to hold subassemblies 240 and 250 in a fixed position with respect to each other may also be including in connector 200. In the example illustrated, clips 270A and 270B hold the terminal subassemblies 240 and 250 together. In this example, each clip 270A and 270B is a U-shaped piece of metal that fits into channels in subassemblies 240 and 250 such that the arms of the “U” are expanded when in place to exert a spring force that presses subassemblies 240 and 250 together. Additionally, clip 270A may include tabs 272A and 272B and clip 270B may include tabs 272C and 272D. These tabs may engage housing 206, holding the subassemblies in the housing. Alternatively or additionally, cavity 284 may be sized and shaped to hold the terminal subassemblies in a designed location with respect to the mating interface and/or with respect to each other.

The strain relief portions 244 and 254 may be molded after the insulative overmolds 242 and 252. As shown in FIG. 5C, the first formed insulative overmolds 242 and 252 may have projections around which the respective strain relief portion 244 or 254 is overmolded, such that the insulative overmolds and strain relief portions, 242 and 244 or 252 and 254, are held together once formed. The strain relief portions 244 and 254 may be molded after the intermediate portions of the first type of conductive elements 222 are bent through a 90° angle. Accordingly, both overmolds have shapes, including features as illustrated in the figures, which may be readily formed via a molding operation.

In some embodiments, such as illustrated in FIGS. 5A-5D, contact portions 223 of the first type of the conductive elements 222 may be arranged between contact portions 227 of the second type of the conductive elements 226, such as between two groups of contact portions 227 of the second type of the conductive elements 226. In some embodiments, low-speed signals (e.g., with data rates less than 1 Gbps) may be transmitted via the first type of the conductive elements 222, which may have mating end portions 224 configured for electrical connection to the low-speed subassembly 230. In some embodiments, high-speed signals (e.g., with data rates in excess of 1 Gbps) may be transmitted through the second type of the conductive elements 226, which may have ends configured for attachment to cables. Using the first type of the conductive elements 222 having mating end portions 224A configured for attachment to low-speed subassembly 230 which may be configured for direct attachment to a printed circuit board for at least some signals may allow for greater signal density. Using the second type of the conductive elements 226 having tails configured for attachment to cables for at least some signals may enable higher signal integrity to and from high-speed (for example, signals of 25 GHz or higher) components on the printed circuit board, such as in configurations where signal traces in printed circuit boards may not provide a required signal integrity over signal paths of the length separating connector 200 and those high-speed components.

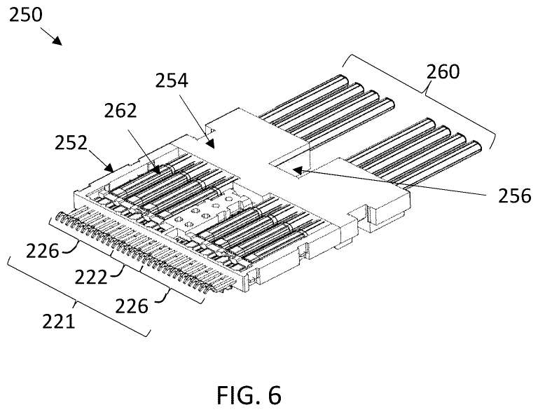

A top view of terminal subassembly 250 is shown in FIG. 6. (The bottom of terminal subassembly 250 is visible in FIG. 5D.) The terminal subassembly provides one row of mating contact portions of the conductive elements within the receptacle connector 200. The terminal subassembly 250 illustrated in FIG. 6A may be formed by stamping a row of conductive elements from a sheet of metal. This row of conductive elements 221 may comprise conductive elements of a first type 222 and a second type 226.

In some embodiments, a row direction of a row of conductive elements, (the direction along which different conductive elements of the row are spaced from each other), is arranged in a plane that is parallel to a plane of a printed circuit board to which the connector is mounted. In some embodiments, a row direction is perpendicular to a plugging direction in which a transceiver is inserted into a cage enclosing the receptacle connector via a front opening of the cage.

In accordance with some embodiments, conductive elements in a row, such as conductive elements of the illustrated terminal assemblies, may be stamped from a sheet of metal, and initially held in position with tie bars. The housing, such as insulative overmold 252, may be overmolded on those conductive elements so as to lock the conductive elements in position. Then the tie bars may be severed to create electrically insulated conductive elements. The positions of the conductive elements may be set by the stamping die used to cut the conductive elements from the sheet of metal, even after the tie bars are severed.

FIG. 6 illustrates that cables 260 may be terminated to a second type of the conductive elements 226. Such cables 260 are shown in FIG. 6. In this example, the cables 260 are twinax cables, each with two wires (though other number of wires are also possible), each of which is terminated to one of a pair of signal conductors. The terminations are not visible in FIG. 6A because they are covered by a ground shield 262, which has concave sections partially surrounding the terminations. That ground shield 262 also has flat portions, which may be welded or otherwise attached to the ground conductors on either side of the pairs of signal conductors. Alternatively or additionally, the ground shields and ground conductors may be pressed together making electrical connection, without being mechanically joined.

Terminal subassemblies 240 and 250 further comprise features configured to facilitate nesting and stacking of the terminal subassemblies 240 and 250. For example, terminal subassemblies 240 and 250 may include at least one opening formed in an insulative overmold 242 or 252 or formed in a strain relief portion 244 or 254. For example, in FIG. 6, strain relief portion 254 includes an opening 256 aligned with and configured to receive a protrusion 246 of terminal subassembly 240. In this manner, the terminal subassemblies 240 and 250 may be stacked in a nested fashion.

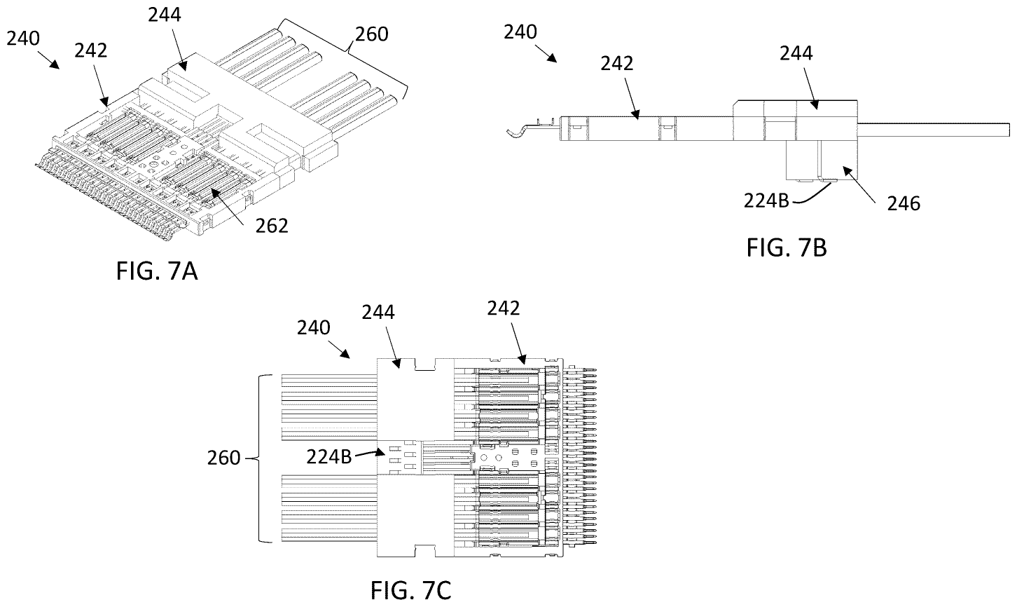

FIGS. 7A-7C provide top, side and bottom views of terminal subassembly 240. In FIGS. 7A-7C, mating end portions 224B of the first type of conductive element contained within terminal subassembly 240 may have portions bent to pass through protrusion 246. This configuration positions each of the mating end portions 224B of the electrical conductors to be connected to low-speed subassembly 230 even when the terminal subassemblies 240 and 250 are stacked with terminal subassembly 240 on top of terminal subassembly 250. Protrusion 246 may fit within opening 256 of terminal assembly 250. In this example, protrusion 246 may have a height that approximates the thickness of the housing a terminal assembly 250 such that mating end portions 224A and 224B are in a same plane.

FIG. 7C, showing the lower side of the terminal subassembly 240, reveals that the mating end portions of the ground conductors are connected together and include tabs that contact the cables 260. Each of the twinax cables 260 may include a shield wrapped around an insulated pair of wires. At the cable termination, that cable shield may be exposed. The tabs of the ground conductors may flex when the cable is pressed against them such that the cable 260 is not deformed yet may make electrical contact to the ground conductors. Welding the ground shield to the ground conductors may provide force on the cable 260 to press the cable into the tabs of the ground conductors. In this example, the twinax cables 260 are drainless cables such that connection is made to the wrapped shield. However, it should be appreciated that other techniques may be used for making a connection between the ground conductors in the terminal subassembly and the shields of the cables 260, including tabs or other structures on the common ground shield 262 shown in FIG. 7C.

The midboard ends of the cables 260 are not visible in FIGS. 2A-10D. In some example applications, a plug connector may be attached to the midboard end of the cables 260. The plug may be configured to mate with a low-profile connector installed at the midboard. That plug connector may be attached at any suitable time, including before the cables 260 are terminated to the terminal subassemblies 240 and 250, after the cables 260 are terminated to the terminal subassemblies 240 and 250 and before the terminal subassemblies 240 and 250 are stacked into a receptacle subassembly 220 or after the receptacle subassembly 220 is formed.

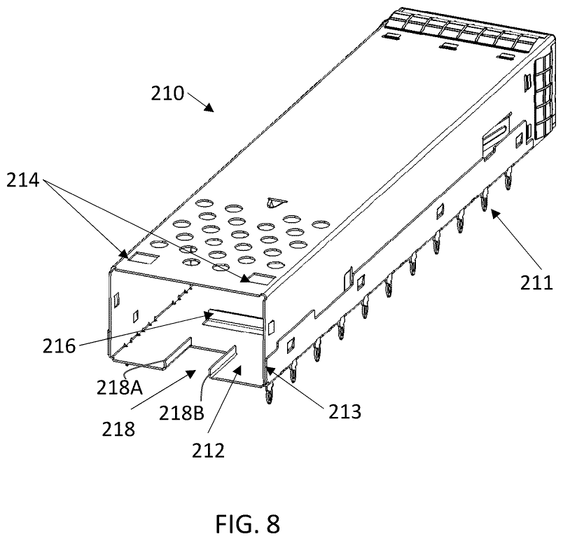

FIG. 8 illustrates cage 210, showing a rear opening into a channel without connector 200 installed. Receptacle subassembly 220 may be removably inserted into the channel through this rear opening. Cage 210 may comprise one or more features to retain and/or position receptacle subassembly 220. In the illustrated example, those elements include engagement elements 214, which are configured to engage with complementary engagement elements on the receptacle subassembly 220 to position and retain the receptacle subassembly 120 within the channel.

In this example, engagement elements 214 are openings in a top wall of the cage that receive complementary engagement elements on housing 280. The complementary engagement elements may be, for example, beams 282A and 282B (FIG. 4A), which in this example are integrally formed with the housing 280. Beams 282A and 282B are compliant and may be pressed into housing 280 as receptacle subassembly 220 is inserted into cage 210. Here, beams 282A and 282B have a rearward facing surface perpendicular to the direction of insertion of receptacle subassembly 220 into cage 210 that, when receptacle subassembly 220 is inserted into cage 210, engage with an edge of the openings of engagement elements 214, blocking withdrawal receptacle subassembly 220. To remove receptacle subassembly 220 from cage 210, beams 282A and 282B again may be depressed.

Alternatively, or additionally, cage 210 may include features that block insertion of receptacle subassembly 220 beyond a predetermined location. In this example, tab 216 is configured to engage a surface of receptacle subassembly 220 when receptacle subassembly 220 is inserted to a designed location.

Cage 210 may also include features to receive and/or position low-speed subassembly 230 and/or position cage 210 relative to low-speed subassembly 230 after it has been mounted to a PCB. In this example, slot 218, in the floor of the cage, receives low-speed subassembly 230. Slot 218 is configured to surround at least a portion of the low-speed subassembly 230. Low-speed subassembly 230 may be positioned within slot 218 either before cage 210 is mounted to a printed circuit board or as cage 210 is being mounted to the printed circuit board.

Regardless of when low-speed subassembly 230 is positioned within slot 218, relative positions of the receptacle subassembly 220 and low-speed subassembly 230 may be established by cage 210, which may be stamped by a die with low variation in dimensions. When each subassembly 220 and 230 is interfaced with features of cage 210, including engagement elements 214 and slot 218, mating end portions 224A and 224B of the first type of conductive elements of the receptacle subassembly are in contact with the mating contact portions 233 of the conductive elements 232 of the low-speed subassembly 230. In alternative embodiments, additional elements may be used in conjunction with cage 210 to position and/or retain subassemblies 220 and 230 of connector 200.

In the illustrated embodiment, the cage 210 includes a channel into which a plug may be inserted for mating with the illustrated I/O connector. The plug, for example, may be a mating portion of a transceiver that may terminate an optical or electrical cable. Positioning the receptacle connector 200 with respect to the cage 210 may position the contact portions of the conductive elements 221 of the receptacle subassembly 220 within the channel for mating with pads on a plug connector. This positioning may be achieved with small variability from connector to connector as a result of positioning the contact portions of both types of conductive elements 121 within the receptacle subassembly 220.

As shown in FIG. 8, cage 210 may have connection elements 211 extending from a lower edge or other portion of the cage 210 and configured for connection to a printed circuit board. In some examples the connection elements 211 may use the same attachment technology as is used for mounting subassembly 230 to the printed circuit board. In the illustrated embodiment connection elements 211 comprise pressfits configured for insertion into corresponding holes in a printed circuit board. In some embodiments, the connection elements 211 of the cage 210 position the cage 210 relative to the printed circuit board. The connection elements 211 of the cage 210 may be larger than pressfits (such as tails 234) of the conductive elements 232 of the low-speed subassembly 230 in some embodiments. The connection elements 211 of the cage 210 may provide substantially more retention force than pressfits (such as tails 234) of the conductive elements 232 of the low-speed subassembly 230 such as a multiple of 1.5 or more greater retention force. Accordingly, securing the receptacle connector 200 to the cage 210 may provide substantial robustness to the overall I/O connector assembly.

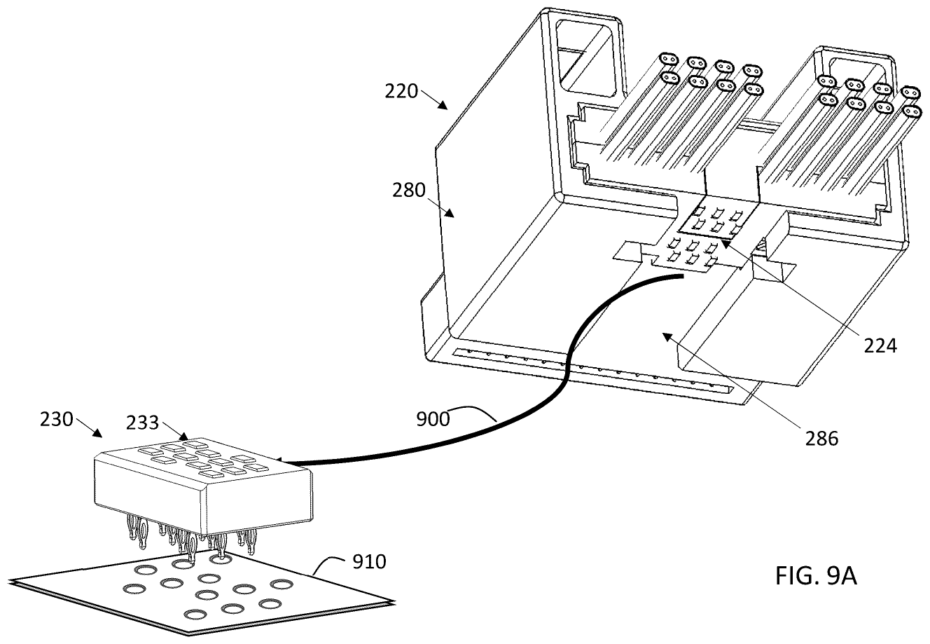

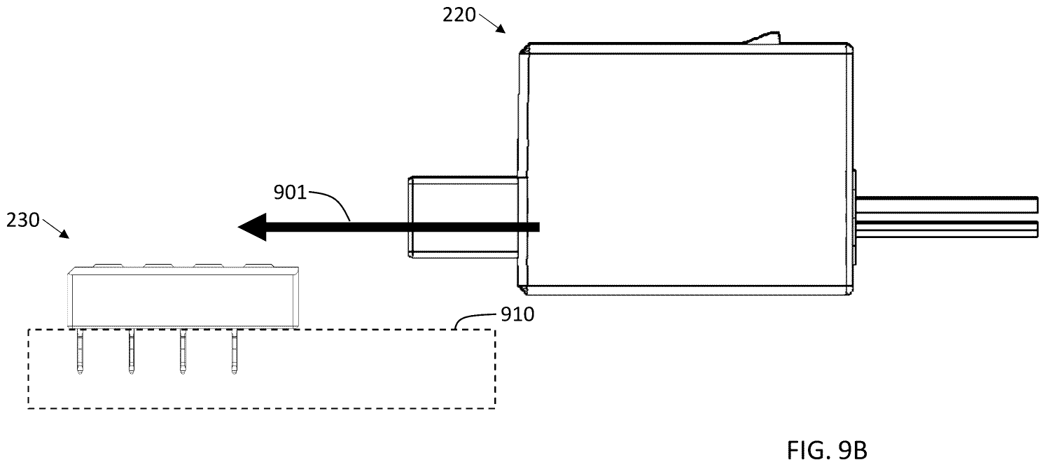

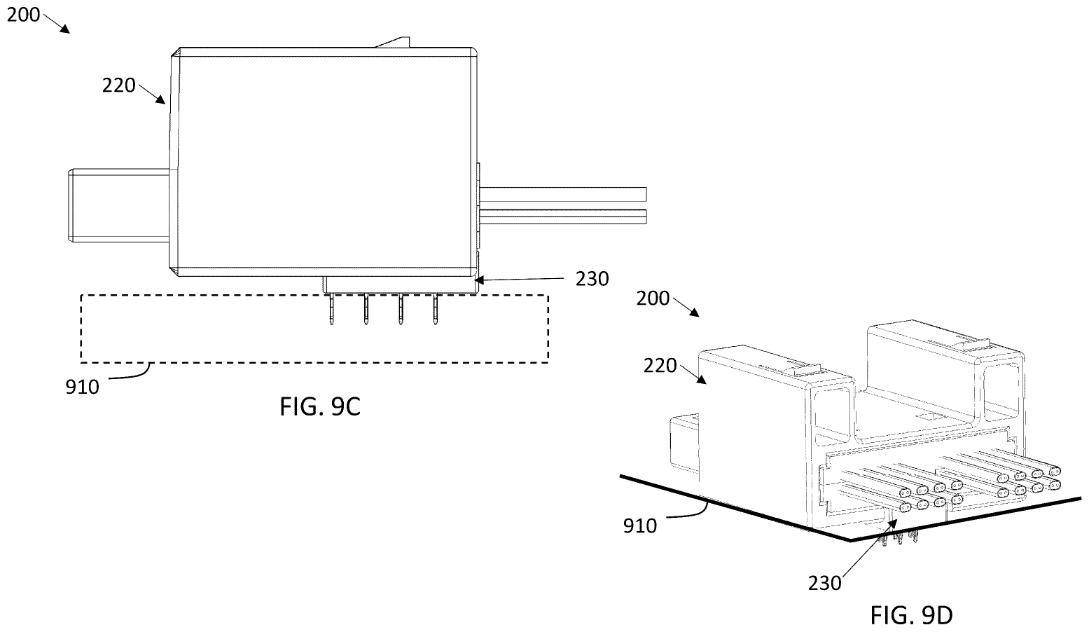

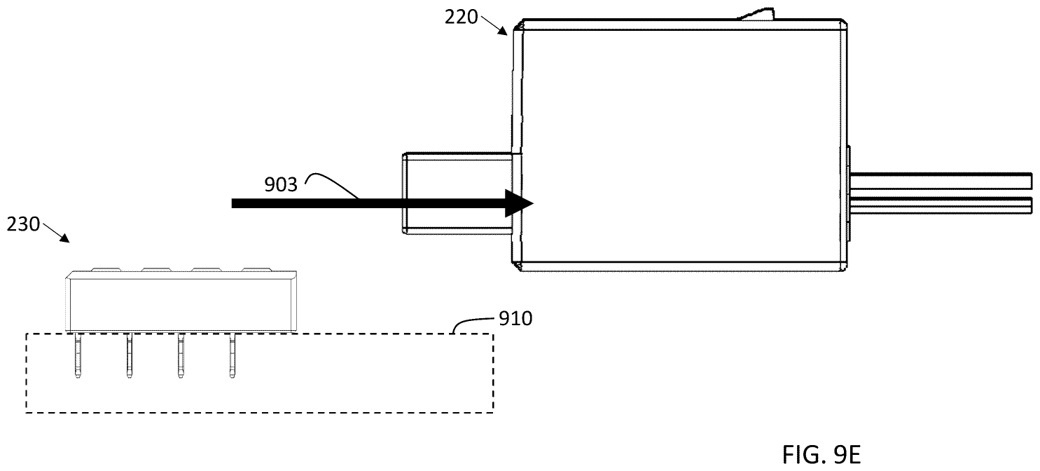

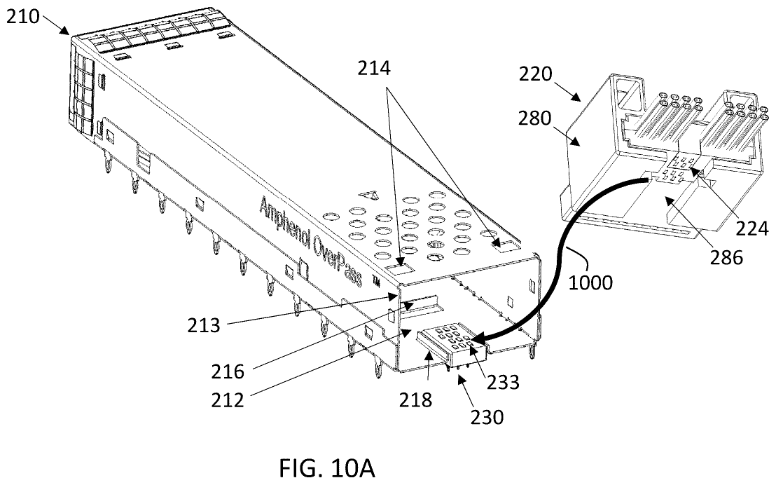

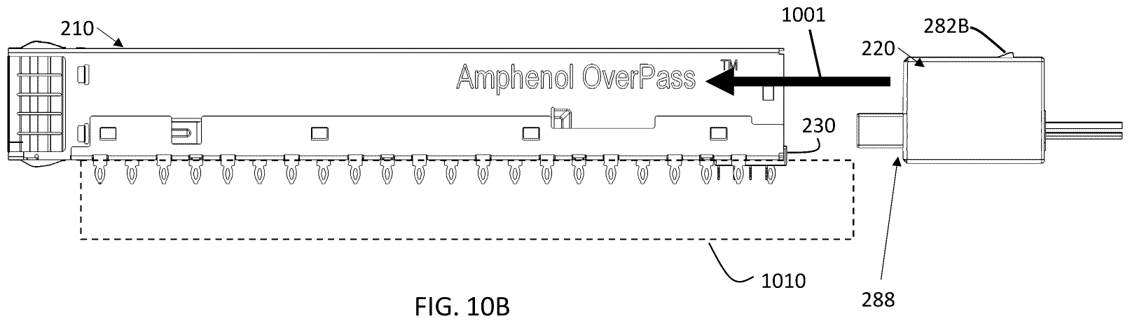

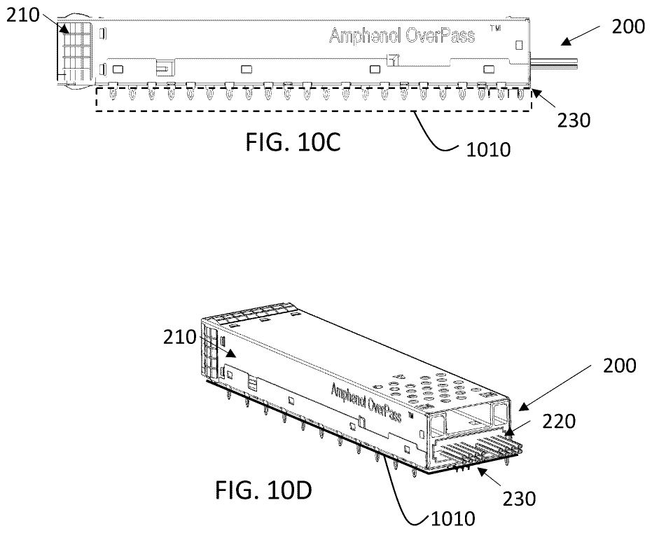

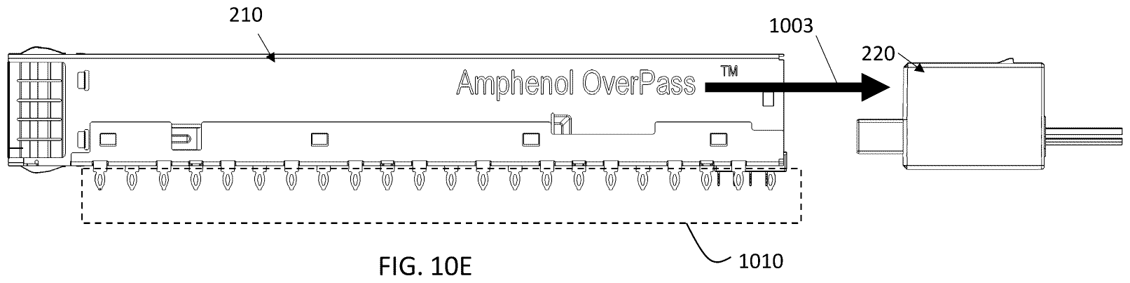

FIGS. 9A-10E illustrate an exemplary process of assembling an interconnection system with a connector configured to couple some signals directly to a PCB 910 and other signals to cables, which in turn may be coupled to PCB 910 remote from the connector or other locations within an electronic device. FIGS. 9A-9E illustrate assembling a receptacle connector without a cage. FIG. 9A illustrates a low-speed subassembly 230, which may be mounted to a printed circuit board 910 with a permanent or semi-permanent mounting technology, such as press fits. The bottom of receptacle subassembly 220, where mating end portions 224 of first type of conductors 221 extend from the subassembly housing, is visible. When the two subassemblies 220 and 230 are assembled, these mating end portions 224 are in electrical contact with mating contact portions 233 of conductive elements 232 of low-speed subassembly 230. Arrow 900 illustrates motion of receptacle subassembly 220 to mate subassembly 220 with subassembly 230. Either or both of the subassemblies 220 and 230 may include features to position and/or secure the subassemblies in a mated state. Housing 280, for example, may comprise a slot 286 to facilitate the connection of the receptacle subassembly 220 and the low-speed subassembly 230.

FIG. 9B illustrates a process for assembling the receptacle subassembly 220 with the low-speed subassembly 230. In this embodiment the low-speed subassembly 230 may be mounted to a printed circuit board 910. Low-speed subassembly 230 may be mounted by pressing onto the printed circuit board 910. The receptacle subassembly 220 may be slid linearly over the low-speed subassembly 230 such that the low-speed subassembly is positioned within the slot 286. The receptacle subassembly 220 may be slid until the mating end portions 224 of conductive elements 222 of a first type are in electrical contact with the respective mating contact portions 233 of conductive elements 232. Arrow 901 illustrates the direction of sliding for the receptacle subassembly 220. The mating end portions 224 of conductive elements 222 of a first type of receptacle subassembly may wipe onto the mating contact portions 233 of conductive elements 232 of the low-speed subassembly 230 during this assembly operation.

FIGS. 9C and 9D illustrate an assembled receptacle connector 200. Although not show, the assembly process may also include connecting opposite ends of cables 260 to a midboard location on the printed circuit board or other location within the electronic device containing the connector 200 either before or after the operations illustrated. The opposite ends of cables 260, for example, may be terminated with a separable connector, which may be mated to and removed from a structure at the midboard or other location within the electronic system, such that receptacle subassembly 220 may be connected and/or disconnected only at locations where separable connections are formed, enabling such connection or disconnection to be performed with little potential for damage and/or wear on the components of the electronic device.

FIG. 9E illustrates an exemplary process for disassembling or removing receptacle subassembly 220 from receptacle connector 200, such that the receptacle subassembly 220 is separated from low-speed subassembly 230. Even though receptacle subassembly 220 is removed, low-speed subassembly 230 may be left mounted to PCB 910. The arrow 903 demonstrates the direction the receptacle subassembly may be slid along during disassembly. Receptacle subassembly 220 may be configured to be removed from receptacle connector 200 after assembly. Although not show, the disassembly process may also include disconnecting ends of cables 260 from a midboard location on the printed circuit board, such as by disconnecting separable connections.

After removing receptacle subassembly 220, receptacle subassembly 220 may be re-assembled with low-speed subassembly 230, with or without first being repaired or otherwise modified. Alternatively or additionally, a new receptacle subassembly may be assembled with the low-speed subassembly 230, according to the above-described method. A receptacle subassembly 220 may be removed and replaced to address reliability issues or replace non-functioning components with functioning components. Alternatively or in addition, components within the receptacle subassembly may be configured to be removed and replaced. Enabling the replacement of receptacle subassemblies in such a connector cases maintenance and increases the longevity of a particular connector within a system.

Though not illustrated in FIGS. 9A-9E, an electronic system may include one or more members that position and/or secure receptacle subassembly 220 with respect to low-speed subassembly 230. In some examples, cage 210 may, in whole or in part, position and/or secure receptacle subassembly 220 with respect to low-speed subassembly 230.

FIGS. 10A-10E illustrate a process of assembling a receptacle connector 200 within cage 210. FIG. 10A illustrates cage 210 and low-speed subassembly 230 positioned together. Both may be mounted to a printed circuit board (not shown in FIG. 10A), such as printed circuit board 910. Holes in the printed circuit board may be positioned such that when cage 210 is mounted to the printed circuit board, the low-speed subassembly is positioned within slot 218 of the cage 210. Slot 218 is configured to surround at least a portion of low-speed subassembly 230.

Slot 218 may position low-speed subassembly 230 relative to cage 210 and/or enable low-speed subassembly 230 to be mounted to the same PCB to which cage 210 is attached. As visible in FIG. 8, slot 218 may be bounded by internal walls 218A and 218B of cage 210, which may aid in positioning cage 210 relative to low-speed subassembly 230. Such walls, for example, may be integral with the floor of cage 210 and may be formed, for example, by stamping tabs extending into slot 218 when a sheet of metal is stamped for form a blank for cage 210 that is then folded into the shape illustrated.

In the example illustrated, slot 218 is in a floor of cage 210 such that, with low-speed subassembly 230 within slot 218, tails 234 extend below the floor for mounting to a printed circuit board and mating contact portions 233 exposed within the channel of cage 210 for mating with receptacle subassembly 220. In FIG. 10A, the bottom of receptacle subassembly 220, including mating end portions 224 of first type of conductors 221, is visible. When the two subassemblies 220 and 230 are assembled, mating end portions 224 are in electrical contact with mating contact portions 233 of conductive elements 232 of low-speed subassembly 230. The arrow 1000 indicates where the receptacle subassembly may be placed in an assembled state. Housing 280 may comprise a slot 286 to facilitate connection of the receptacle subassembly 220 and the low-speed subassembly 230.

FIG. 10B illustrates a process for assembling the receptacle subassembly 220 with the low-speed subassembly 230 and cage 210. In this embodiment the low-speed subassembly 230 and cage 210 may be mounted to a printed circuit board, illustrated schematically as PCB 1010. Low-speed subassembly 230 and cage 210 may each be mounted via pressing onto the printed circuit board 1010. Low-speed subassembly 230 and cage 210 may be mounted in any suitable order, for example the low-speed subassembly 230 may first be mounted to printed circuit board 1010 and the cage 210 may be mounted over the low-speed subassembly 230. The receptacle subassembly 220 may be slid linearly in direction of arrow 1001 over the low-speed subassembly 230 and into the channel 212 of the cage 210, such that the low-speed subassembly is positioned within the slot 286. The receptacle subassembly 220 may be slid until the mating end portions 224 of conductive elements 222 are in electrical contact with the respective mating contact portions 233 of conductive elements 232. The mating end portions 224 of conductive elements 222 may wipe along the mating contact portions 233 of conductive elements 232. The walls 213 of the cage 210 may also facilitate the positioning of the receptacle subassembly 220. A stop tab 216 (FIG. 10A) may be provided in the cage 210, such as by stamping and bending the tab in the floor or other side of the cage 210. Tab 216 may interact with side 288 of the receptacle subassembly and ensure proper positioning by blocking receptacle subassembly 220 from being further inserted into the cage. During assembly, engagement features, such as beams 282A and 282B of the receptacle subassembly 220 may be depressed, and may return to an original, non-depressed position when the receptacle subassembly 220 is in an assembled position. In this assembled position, engagement features, such as beams 282A and 282B of the receptacle subassembly 220 may interact with engagement elements 214 of the cage to block the receptacle subassembly from being withdrawn from the channel once in this position. Beams 282A and 282B, however, may be depressed to disengage from engagement elements 214 such that the receptacle subassembly may be withdrawn.

FIGS. 10C and 10D illustrate an assembled receptacle connector 200 within cage 210. The cage and at least signal conductors designated as low-speed signal conductors may be mounted to a PCB, such as PCB 1010. Although not shown, the assembly process may also include connecting ends of cables 260 to a midboard location of PCB 1010 or other location within an electronic system.

FIG. 10E illustrates a process for disassembling or removing receptacle subassembly 220 from receptacle connector 200, such that the receptacle subassembly 220 is separated from low-speed subassembly 230 and cage 210. The arrow 1003 demonstrates the direction in which the receptacle subassembly may be slid during disassembly. Receptacle subassembly 220 may be configured to be removed from receptacle connector 200 after assembly, such as by depressing engagement features such as beams 282A and 282B to disengage those elements from engagement elements 214. As described above in connection with FIG. 9E, the disassembly process may involve removing receptacle subassembly 220, modifying it and replacing it, or installing a new receptacle subassembly.

Using techniques as described herein, subassemblies 220 and 230 of connector 200 may mate at a separable, internal interface. That interface may be a pressure mount interface, with sufficient pressure being generated at the mating interface for reliable electrical connectors by using one or more members to force subassemblies 220 and 230 together. Cage 210 may be such a member.

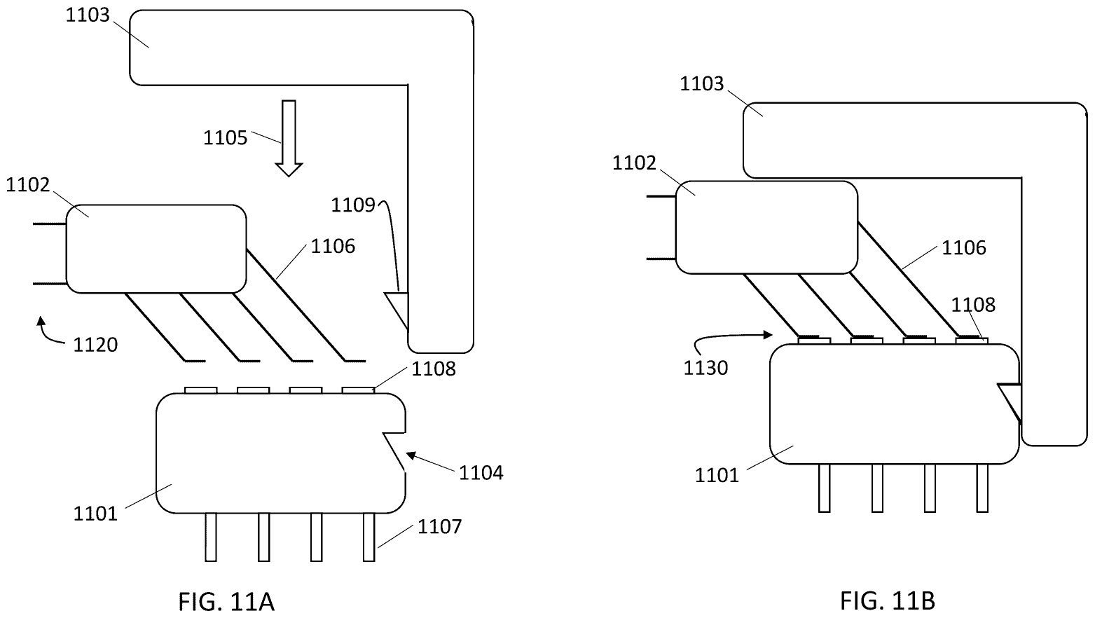

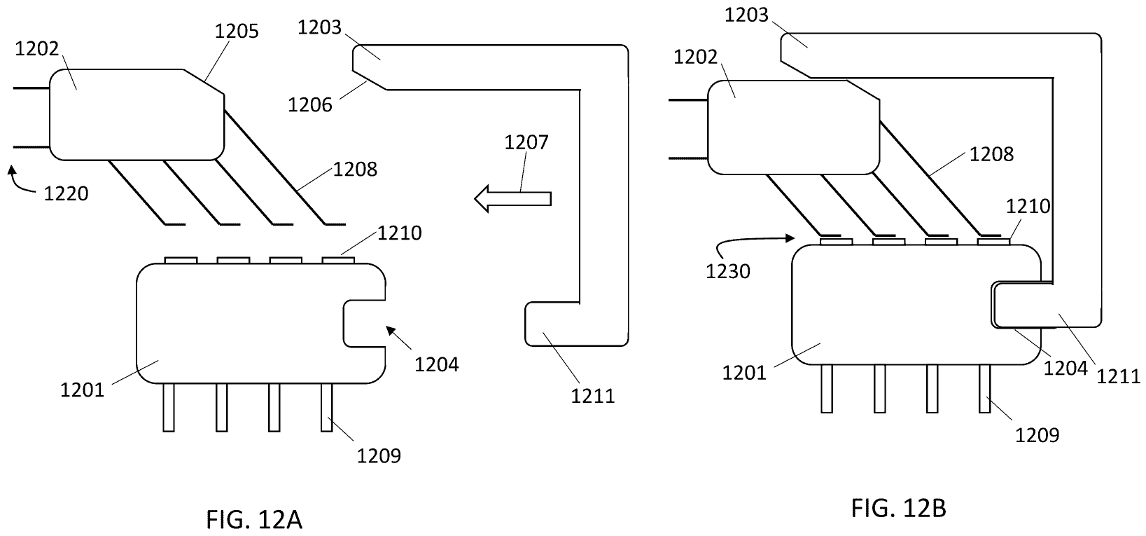

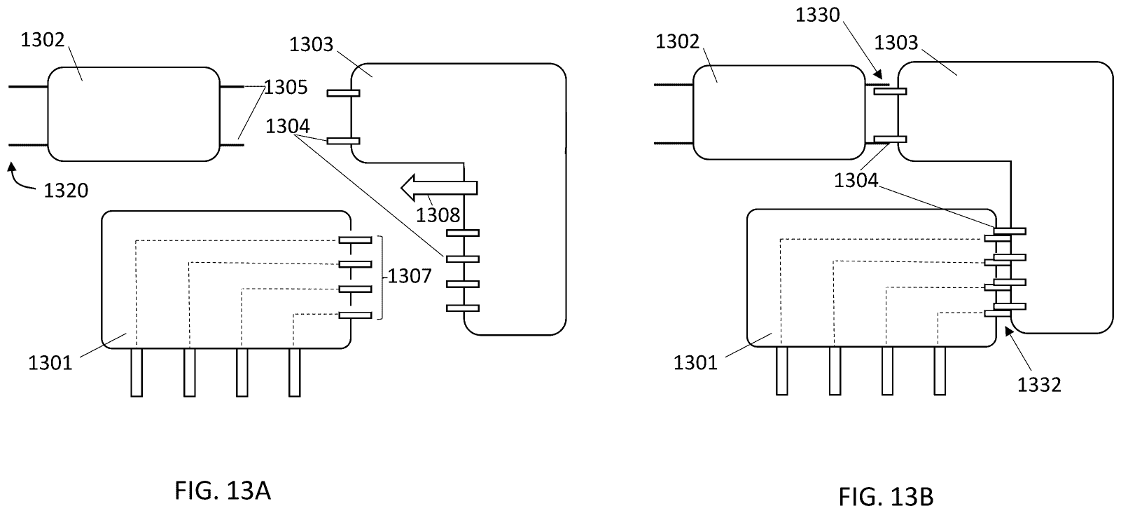

FIGS. 11A-13B are schematic illustrations of alternative embodiments and processes for assembly of a connector with electrical connections between subassemblies. FIGS. 11A-12B illustrate connectors in which pressure at an internal mating interface between subassemblies is generated by a member, such as a clip that forces the subassemblies together. FIGS. 13A-13B illustrate an example in which the electrical interface is formed through a component that has conductive elements with mating portions at each end.

In the example of FIGS. 11A-11-B, a low-speed conductor assembly 1101 is provided as a subassembly. In this example, subassembly 1102 may mate at an internal interface 1130 to low-speed conductor assembly 1101. Conductive elements within subassembly 1102 may have contact portions that are exposed at an external mating interface 1120 and/or coupled to other conductive elements that have contact portions exposed at the external mating interface 1120. Low-speed conductor assembly 1101 may be configured similarly to subassembly 230, as described above. Subassembly 1102 may be configured similarly to receptacle subassembly 220, as described above. Though not shown in FIGS. 11A and 11B, subassembly 1102 may include conductive elements terminated to cables, which may be used to carry high-speed signals.

Low-speed conductor assembly 1101 and subassembly 1102 may differ from the subassemblies described above in that they include an alternative structure to force the subassemblies together, which may be used instead of or in addition to a cage for that purpose. In the example illustrated, the member holding the subassemblies together generates force at the internal mating interface 1130. In the illustrated example, clip 1103 holds the subassemblies together. In this example, clip 1103 includes a hook 1109 configured to engage with at least one engagement feature 1104 of the low-speed conductor assembly 1101, to secure the low-speed conductor assembly 1101 and subassembly 1102 together. Arrow 1105 illustrates a direction of motion of clip member 1103 to secure the low-speed conductor assembly 1101 and subassembly 1102 together. FIG. 11B illustrates the low-speed conductor assembly 1101 and subassembly 1102 in an assembled state secured with the clip member 1103. In the assembled state, conductive elements of a first type 1106 of the subassembly 1102 are in electrical contact with pad portions 1108 of the conductive elements 1107 of the low-speed conductor assembly 1101. Clip 1103 may be removed from the assembled state to facilitate disassembly and replacement of subassembly 1102.

FIGS. 12A-12B, illustrate an alternative clip design for holding together subassemblies of a connector. In this example, a connector includes a low-speed conductor assembly 1201 and a subassembly 1202. In this example, subassembly 1202 may mate at an internal interface 1230 to low-speed conductor assembly 1201. Conductive elements within subassembly 1202 may have contact portions that are exposed at external mating interface 1220 and/or coupled to the other conductive elements that have contact portions exposed at the external mating interface 1220. Subassembly 1202 may be configured similarly to receptacle subassembly 220, as described above. Though not shown in FIGS. 12A and 12B, subassembly 1202 may include conductive elements terminated to cables, which may be used to carry high-speed signals.

FIGS. 12A and 12B illustrate an alternative structure that may hold subassemblies together. In the example illustrated, the member holding the subassemblies together generates force at the internal mating interface 1230. In the illustrated example, clip 1203 holds the subassemblies together. In this example, clip 1203 includes a protrusion 1211 configured to engage with at least one engagement feature 1204 of the low-speed conductor assembly 1201, to secure the low-speed conductor assembly 1201 and the subassembly 1202 together. Clip 1203 may also include a guide feature 1206 which may interact with a guide surface 1205 of subassembly 1202, to facilitate assembly and to force subassembly 1202 towards low-speed conductor assembly 1201 as clip 1203 is installed onto the subassemblies. Arrow 1207 illustrates a direction of motion of clip member 1203 to secure the low-speed conductor assembly 1201 and subassembly 1202 together.

FIG. 12B illustrates the low-speed conductor assembly 1201 and subassembly 1202 in an assembled state secured with the clip member 1203. In the assembled state, conductive elements of a first type 1208 of the subassembly 1202 are in electrical contact with pad portions 1210 of the conductive elements 1209 of the low-speed conductor assembly 1201. Clip 1203 may be removed from the assembled state to facilitate disassembly and replacement of subassembly 1202.

In other embodiments, two connector subassemblies may be separably connected through a third subassembly, such that a subassembly terminated to one or more cables may be formed and/or modified separately and integrated into a connector. In FIGS. 13A-13B, a low-speed conductor assembly 1301 is provided as is a subassembly 1302. In this example, subassembly 1302 may electrically connect to low-speed conductor assembly 1301 via clip 1303. Conductive elements within subassembly 1302 may have contact portions that are exposed at an external mating interface 1320 and/or coupled to other conductive elements that have contact portions exposed at the external mating interface 1320. Subassembly 1302 may be configured similarly to receptacle subassembly 220, as described above. Though not shown in FIGS. 13A and 13B, subassembly 1302 may include conductive elements terminated to cables, which may be used to carry high-speed signals.

FIGS. 13A and 13B illustrate an alternative structure for connecting subassemblies. In this example, clip 1303 may have conductive elements 1304 embedded within. First ends of conductive elements 1304 may electrically connect to contact portions of conductive elements 1305, contained within subassembly 1302, at a first internal mating interface 1330. Second ends of conductive elements 1304 may electrically connect to contact portions of conductive elements 1307, contained within low-speed conductor assembly 1301, at a second internal mating interface 1332. Arrow 1308 illustrates a direction of motion of clip 1303 to connect the low-speed conductor assembly 1301 and subassembly 1302. FIG. 13B illustrates the low-speed conductor assembly 1301 and subassembly 1302 in an assembled state, electrically connected with clip 1303. In the assembled state, conductive elements 1304 electrically connect conductive elements 1305 of the subassembly 1302 and conductive elements 1307 of the low-speed conductor assembly 1301. Clip 1303 may be removed from the assembled state to facilitate disassembly and replacement of subassembly 1302.

In this example, the conductive elements within clip 1303 may have contact elements 1304 complementary to the internal contact elements of 1305 and 1307 of low-speed conductor assembly 1301 and subassembly 1302. The subassemblies may be configured such that, when pressed together for mating, one or both of the contact elements 1304, 1305 and 1307 at each internal interface may be deflected to generate a mating contact force. Mating contacts shaped as beams and mating contact portions shaped as blades, for example, may be used for this purpose.

### Examples

In one example, an electrical connector may comprise a receptacle subassembly and a low-speed subassembly. The receptacle subassembly may comprise at least one terminal subassembly which comprises a plurality of conductive elements. Each conductive element of the plurality of conductive elements may comprise a contact portion, an end portion and an intermediate portion joining the contact portion and the end portion. The contact portions of the plurality of conductive elements may be positioned in a row. The plurality of conductive elements comprises conductive elements of a first type and a second type. The conductive elements of the first type may have intermediate portions with a 90-degree bend and end portions configured as mating end portions configured for electrical connection to the low-speed subassembly. The conductive elements of the second type have end portions configured as tails configured for a cable termination. The low-speed subassembly comprises a plurality of conductive elements, wherein each conductive element comprises a mating contact portion, a tail and an intermediate portion joining the mating contact portion and the tail. The mating contact portions of the plurality of conductive elements are positioned in rows, and the tails are configured for attachment to a printed circuit board. The receptacle subassembly is configured to nest with the low-speed subassembly in an assembled state and is further configured to be removed from the assembled state.

In another example, an electrical connector may comprise a receptacle subassembly and a low-speed subassembly. The receptacle subassembly may comprise at least one terminal subassembly which comprises a plurality of conductive elements, wherein each conductive element of the plurality of conductive elements may comprise a contact portion, an end portion and an intermediate portion joining the contact portion and the end portion. The contact portions of the plurality of conductive elements may be positioned in a row. The plurality of conductive elements may comprise conductive elements of a first type and a second type. The conductive elements of the first type may have intermediate portions with a 90-degree bend and end portions configured as mating end portions configured for electrical connection to the low-speed subassembly. The conductive elements of the second type may have end portions configured as tail portions configured for a cable termination. The low-speed subassembly may comprise a plurality of conductive elements, wherein each conductive element may comprise a mating contact portion, a tail and an intermediate portion joining the mating contact portion and the tail. The mating contact portions of the plurality of conductive elements may be positioned in rows, and the tails may be configured for attachment to a printed circuit board. The receptacle subassembly may be configured to nest with the low-speed subassembly in an assembled state and may be further configured to be removed from the assembled state.

In another example, an input/output (I/O) connector may comprise a cage comprising a channel and at least one engagement feature, a receptacle subassembly, and a low-speed subassembly. The receptacle subassembly may comprise at least one terminal subassembly which may comprise a plurality of conductive elements. Each conductive element of the plurality of conductive elements may comprise a contact portion, an end portion and an intermediate portion joining the contact portion and the end portion. The contact portions of the plurality of conductive elements are positioned in a row. The terminal subassembly may comprise an insulative portion holding the plurality of conductive elements. The terminal subassembly may engage the at least one engagement feature of the cage such that the contact portions of the plurality of conductive elements of the terminal subassembly are positioned at predetermined locations within the at least one channel. The low-speed subassembly may comprise a plurality of conductive elements. Each conductive element of the plurality of conductive elements may comprise a mating contact portion, a tail and an intermediate portion joining the mating contact portion and the tail. The low-speed subassembly may engage the at least one engagement feature of the cage such that the low-speed subassembly is positioned at a predetermined location within the at least one channel. The receptacle subassembly may be configured to nest with the low-speed subassembly in an assembled state and may be further configured to be removed from the assembled state.

In another example, electrical connector may comprise a receptacle subassembly and a low-speed subassembly. The receptacle subassembly may comprise a terminal assembly which comprises a plurality of conductive elements, wherein each conductive element of the plurality of conductive elements may comprise a contact portion, an end portion and an intermediate portion joining the contact portion and the end portion. The contact portions of the plurality of conductive elements may be positioned in a row. The plurality of conductive elements may comprise conductive elements of a first type and a second type. The conductive elements of the first type may have intermediate portions with a 90-degree bend and end portions configured as mating end portions configured for electrical connection to the low-speed subassembly. The conductive elements of the second type may have end portions configured as tail portions configured for a cable termination. The low-speed subassembly may comprise a plurality of conductive elements, wherein each conductive element may comprise a mating contact portion, a tail and an intermediate portion joining the mating contact portion and the tail. The mating contact portions of the plurality of conductive elements may be positioned in rows, and the tails may be configured for attachment to a printed circuit board. The terminal subassembly may be configured to nest with the low-speed subassembly in an assembled state and may be further configured to be removed from the assembled state.

### Examples

As a first example, an electrical connector configured for mounting to a printed circuit board may comprise a first mating interface configured for mating the electrical connector to a mating component. The electrical connector may comprise a first subassembly and a second subassembly. The first subassembly may comprise: a first housing, and a first plurality of conductive elements held by the first housing, each of the first plurality of conductive elements comprising a mating contact portion and a tail configured for connection to a printed circuit board. The second subassembly, configured to be separably coupled to the first subassembly at a second mating interface and may comprise a second housing; and a second plurality of conductive elements supported by the second housing, the second plurality of conductive elements comprising conductive elements of a first type and conductive elements of a second type. Each of the second plurality of conductive elements comprises a contact portion exposed at the first mating interface. Each of the first type of conductive elements of the second plurality of conductive elements comprises a mating end portion configured to mate with a mating contact portion of a respective conductive element of the first plurality of conductive elements at the second mating interface. Each of the second type of conductive elements of the second plurality of conductive elements comprises a tail portion configured for cable termination.

The electrical connector of the first example may optionally include one or more of the following features or characteristics:

The connector may include a member configured to hold the first subassembly relative to the second subassembly such that the mating contact portions of the first plurality of conductive elements are coupled to the mating end portions of the first type of conductive elements of the second plurality of conductive elements.

The second housing comprises a receptacle housing comprising a cavity defining the first mating interface; the second plurality of conductive elements are disposed at least in part within the receptacle housing; and the member configured to hold the first subassembly relative to the second subassembly is a cage surrounding at least a portion of the first subassembly and a portion of the receptacle housing.

The cage comprises a tab configured to engage the receptacle housing.

The receptacle housing comprises an engagement feature and the cage comprises an opening configured to engage the engagement feature of the receptacle housing.

The engagement feature of the receptacle housing comprises a depressible beam.

The engagement feature of the receptacle housing is a snap fit joint.

The receptacle housing comprises a slot; and the first subassembly is disposed within the slot.

The cage comprises a channel configured to guide a plug for engagement with the first mating interface of the electrical connector.

The electrical connector may include a cage, and the electrical connector is disposed at least in part within the cage; and the cage is configured to be mounted to a printed circuit board.

The tails of the first plurality of conductive elements are pressfits; and the cage comprises pressfits configured for attachment to the printed circuit board.

The cage comprises a floor having an opening therethrough; and the first subassembly is disposed within the opening of the cage floor.

The member configured to hold the first subassembly relative to the second subassembly comprises a clip configured to separably couple the first and second subassembly together.

The first housing comprises a notch; and the clip comprises a first protrusion extending into the notch in the first housing.

The second housing comprises a second notch; and the clip comprises a second protrusion extending into the second notch in the second housing.

The electrical connector may include a clip configured to engage the first subassembly and the second subassembly.

The first housing comprises a notch; and the clip comprises a first protrusion extending into the notch in the first housing.

The second housing comprises a notch; and the clip comprises a second protrusion extending into the notch in the second housing.

The second subassembly comprises a plurality of terminal subassemblies, each of the plurality of terminal subassemblies comprising a housing; and the second housing comprises the housings of the plurality of terminal subassemblies.

The plurality of terminal subassemblies comprises a first terminal subassembly and a second terminal subassembly; and the housing of the first terminal subassembly comprises a first insulative portion coupled to intermediate portions of at least some conductive elements of the second plurality of conductive elements.

The electrical connector may include a planar mounting interface configured for mounting to a surface of a printed circuit board; and the conductive elements coupled to the first insulative portion are positioned in a row, the row extending in a direction parallel to a plane of the planar mounting interface.

The electrical connector may include a plurality of cables, each of the plurality of cables terminated to the tail portions of conductive elements of the second type of the first terminal subassembly; and at least one strain relief portion mechanically coupled to each of the plurality of cables.

The first mating interface comprises a cavity; contact portions of the conductive elements of the first terminal subassembly are exposed at the first mating interface on a first side of the cavity of the mating interface; and contact portions of the conductive elements of the second terminal subassembly are exposed at the mating interface on a second side of the cavity, opposite the first side of the cavity of the mating interface.

The second housing comprises a receptacle housing; and the first and second terminal subassemblies are disposed, at least in part, within the receptacle housing.

The second housing comprises a slot; and at least a portion of the first subassembly is disposed in the slot of the second housing.

The slot is elongated between a first end, facing the mating interface, and a second end; and the slot of the second housing is open at the first end.

The mating end portions of the first type of the second plurality of conductive elements are disposed in the slot of the second housing such that the second mating interface is in the slot of the second housing.

The mating contact portions of the first plurality of conductive elements or the mating end portions of the first type conductive elements of the second plurality of conductive elements are pads.

The mating contact portions of the first plurality of conductive elements or the mating end portions of the first type conductive elements of the second plurality of conductive elements are compliant beams such that the mating end portions of the first type of conductive elements of the second plurality of conductive elements are mated to mating contact portions of the respective conductive element of the first plurality of conductive elements through a pressure contact.

The mating end portions of the first type of the second plurality of conductive elements are configured to wipe over the mating contact portions of the first plurality conductive elements when the first subassembly and second subassembly are assembled.

The tail of each of the first plurality of conductive elements is configured for a press fit connection.

The first subassembly and the second subassembly are configured to nest.

The electrical connector may be in combination with a printed circuit board and a plurality of cables; the first plurality of conductive elements is mounted to the printed circuit board at a first location; and cables of the plurality of cables are connected to the ends of the second type of conductive elements configured for a cable termination and are electrically coupled to the printed circuit board at a second location, different from the first location.

As a second example, an electrical connector is provided. The electrical connector may comprise a first subassembly. The first subassembly may comprise: a first housing; and a first plurality of conductive elements held by the first housing and configured to be mounted to a printed circuit board. The electrical connector may comprise a second subassembly, configured to be separably coupled to the first subassembly. The second subassembly may comprise: a second housing; and a second plurality of conductive elements supported by the second housing, having conductive elements of a first type and a second type; wherein conductive elements of the first type have mating end portions configured for a separable electrical connection to the first plurality of conductive elements and conductive elements of the second type have tail portions configured for a cable termination.

The electrical connector of the second example may optionally include one or more of the following features or characteristics:

The electrical connector may include a member electrically connecting the first type of conductive elements to the first plurality of conductive elements.

The second subassembly comprises a plurality of terminal subassemblies comprising at least a first and a second terminal subassembly; each of the plurality of terminal subassemblies comprises an insulative portion coupled to intermediate portions of at least some conductive elements of the second plurality of conductive elements; the second housing comprises the insulative portions of the plurality of terminal subassemblies and a connector housing; and the plurality of terminal subassemblies are disposed, at least in part, in the connector housing.

The electrical connector may include a planar mounting interface configured for mounting to a surface of a printed circuit board; and the conductive elements coupled to the insulative portions are positioned in a plurality of rows, the rows extending in a direction parallel to a plane of the mounting interface.

The electrical connector may be in combination with a plurality of cables, each of the plurality of cables terminated to the tail portion of a conductive element of the second type of the first terminal subassembly.

The electrical connector may include a mating interface with a cavity; contact portions of the conductive elements of the first terminal subassembly are exposed at a first side of the cavity at the mating interface; and contact portions of the conductive elements of the second terminal subassembly are exposed at a second side of the cavity at the mating interface, opposite the first side.

The second housing comprises an alignment feature configured to align the first subassembly with the second subassembly.

The electrical connector may be in combination with a cage configured to surround at least a portion of the first subassembly and a portion of the second subassembly. The cage is configured to be mounted to the printed circuit board.

The second housing comprises a plurality of engagement features; and the engagement features are configured to removably couple with a plurality of engagement features of the cage.

The cage comprises: a tab configured to position the second subassembly; a floor comprises an opening configured to receive the first subassembly; a channel configured to guide a plug for engagement with a mating interface of the electrical connector; and pressfits configured for attachment to the printed circuit board.

The first plurality of conductive elements comprises pads; and the mating end portions of the conductive elements of the first type of the second plurality of conductive elements are configured to wipe along the pad portions of the first plurality conductive elements as the second subassembly is separably coupled to the first subassembly.

Each of the first plurality of conductive elements comprises a tail configured for a press fit connection to a printed circuit board.

The first subassembly is nested within the second subassembly.

The electrical connector may include a clip configured to hold the first subassembly relative to the second subassembly.

The first housing comprises a notch; and the clip comprises a first protrusion configured to engage with the notch in the first housing.

The second housing comprises a notch; and the clip comprises a second protrusion configured to engage with the notch in the second housing.

The electrical connector may be in combination with a printed circuit board and a plurality of cables; the first plurality of conductive elements is mounted to the printed circuit board at a first location; and the plurality of cables connected to the tail portions of the second type of conductive element and are coupled to the printed circuit board at a second location, different from the first location.

As a third example, a method of assembling an electronic device is provided. The method may comprise: mounting a first subassembly of an electrical connector to a printed circuit board at a first location, the first subassembly comprising a plurality of electrical conductors each comprising a tail, the mounting comprising mechanically and electrically connecting the tails of the plurality of electrical conductors to the printed circuit board; and coupling a second subassembly to the first subassembly, wherein: coupling the second subassembly to the first subassembly comprises electrically connecting a plurality of conductive elements of a first type in the second subassembly to the first plurality of electrical conductors of the first subassembly; and connecting a plurality of cables of the second subassembly to the printed circuit board at a second location, different than the first location.

The method of the third example may optionally include one or more of the following features or characteristics:

The second subassembly comprises a mating interface of the electrical connector.

The method may include: prior to coupling the second subassembly to the first subassembly, terminating the plurality of cables to a plurality of conductive elements of a second type in the second subassembly.

The method may include: mounting a cage to the printed circuit board at the first location, wherein the cage covers at least a portion of the first subassembly, and the first subassembly is fixed within an opening in a bottom wall of a cage, wherein: mounting the first subassembly to the printed circuit board and mounting the cage to the printed circuit board comprises pressing the cage and the first subassembly onto the printed circuit board; and coupling the second subassembly to the first subassembly comprises inserting the second subassembly into a channel of the cage and engaging at least one engagement feature of the second subassembly with at least one engagement feature of the cage.

The method may include: disengaging the at least one engagement feature of the second subassembly from the at least one engagement feature of the cage; decoupling the second subassembly from the first subassembly; removing the second subassembly from the channel of the cage such that the first subassembly and the second subassembly are decoupled; and disconnecting the cables from the printed circuit board.

The at least one engagement feature of the second subassembly is a depressible tab; the at least one engagement feature of the cage is a slot; engaging at least one engagement feature of the second subassembly comprises depressing the at least one depressible tab of the second subassembly and releasing the at least one depressible tab into the at least one slot of the cage when the second subassembly has been inserted into the cage; and disengaging at least one engagement feature of the second subassembly comprises depressing the at least one depressible tab of the second subassembly and releasing the at least one depressible tab when the second subassembly has been removed from the channel of the cage.

The method may include: coupling a new second subassembly with the first subassembly, such that a second plurality of conductive elements of a first type of the new second subassembly contact the conductive elements of the plurality of conductive elements of the first subassembly; and connecting a second plurality of cables to the printed circuit board at the second location.

The method may include: attaching a clip to the first subassembly and second subassembly.

The method may include: attaching a clip to the first subassembly and second subassembly, wherein decoupling the second subassembly from the first subassembly comprises detaching the clip from the first and second subassembly.

Mounting the first subassembly to the printed circuit board and mounting the cage to the printed circuit board comprises: mounting the first subassembly to the printed circuit board in a first operation; and fitting the cage over the first subassembly in a second operation, after the first operation.

As a fourth example, an electrical connector configured for mounting to a printed circuit board and comprising a first mating interface configured for mating the electrical connector to a mating component. The electrical connector may comprise a first subassembly. The first subassembly may comprise a first housing, and a first plurality of conductive elements held by the first housing, each of the first plurality of conductive elements comprising a tail configured for connection to a printed circuit board and a mating contact portion. The electrical connector may comprise a second subassembly, configured to be separably coupled to the first subassembly at a second mating interface. The second subassembly may comprise: a subassembly housing; and a plurality of terminal subassemblies coupled to the subassembly housing. The plurality of terminal subassemblies may comprise: a second plurality of conductive elements comprising conductive elements of a first type and conductive elements of a second type, wherein: each of the second plurality of conductive elements comprises a contact portion exposed at the first mating interface; each of the first type of conductive elements of the second plurality of conductive elements comprises a mating end portion configured to mate with a mating contact portion of a respective conductive element of the first plurality of conductive elements at the second mating interface; and each of the second type of conductive elements of the second plurality of conductive elements comprises a tail portion configured for cable termination, and a plurality of terminal subassembly housings, each of the plurality of terminal subassemblies comprising a respective terminal subassembly housing holding a subset of the plurality of the second plurality of conductive elements.

The electrical connector of the third example may optionally include one or more of the following features or characteristics:

The subassembly housing comprises a cavity at the first mating interface; and the contact portions of the second plurality of conductive elements are exposed within the cavity.

The cavity is a first cavity; the subassembly housing comprises a second cavity; and the terminal subassembly housings of a plurality of the terminal subassemblies are disposed within the second cavity.

A first terminal subassembly of the plurality of terminal subassemblies is adjacent to a second terminal subassembly of the plurality of terminal subassemblies; the first terminal subassembly comprises a first surface; the first terminal subassembly comprises conductive elements of the first type of the second plurality of conductive elements with mating end portions exposed at the first surface; the second terminal subassembly comprises a second surface; the second terminal subassembly comprises conductive elements of the first type of the second plurality of conductive elements with mating end portions exposed at the second surface; and the first surface and the second surface are coplanar. Having thus described several embodiments, it is to be appreciated various alterations, modifications, and improvements may readily occur to those skilled in the art. Such alterations, modifications, and improvements are intended to be within the spirit and scope of the invention.

As one example, separable interfaces between subassemblies were illustrated as having a beam on pad configuration. Separable connections alternatively or additionally may be made with contact portions of other configurations, such as beam on beam, or blades inserted between opposing beams.

As another example, FIG. 1 illustrates an electronic device in which a connector having one or more of the features described herein might be used. It should be appreciated that FIG. 1 shows a portion of such a device, and the device may include additional components not expressly illustrated. For example, board 110 may be larger than illustrated and may contain more components than illustrated. Likewise, board 118 may be larger than illustrated and may contain components. Moreover, multiple boards parallel to board 118 and/or parallel to board 110 may be included in the device.

A connector with one or more of the features described herein might also be used with board configurations other than the illustrated orthogonal configuration. The midboard cable termination assembly might be used on a printed circuit board connected to another, parallel printed circuit board or might be used in a daughter card that plugs into a backplane at a right angle. As yet another example, the midboard cable termination assembly might be mounted on a backplane.

As yet another example of a possible variation, a connector mounted to board 110 is coupled to a midboard cable termination assembly mounted on board 110 with cables. That configuration is not, however, a requirement, as cables terminated to a connector with one or more of the features described herein may be connected directly to the board, an integrated circuit or other component, or even directly to the board 110 to which the midboard cable termination assembly is mounted. As another variation, the cable may be terminated to a different printed circuit board or other substrate. For example, a cable extending from a connector mounted to board 110 may be terminated, through a connector or otherwise, to a printed circuit board parallel to board 110. Alternatively, cables extending from an I/O connector mounted to a first printed circuit board may be terminated to a daughter card containing a processor that is attached to the first printed circuit board or otherwise integrated into the electronic device.

As another example, housings, such as for the connector, subassemblies and/or terminal assemblies, may be made of insulative material, such as a plastic or nylon via injection molding or insert molding. In some examples, the housings may alternatively or additionally include conductive or lossy portions, such as may be formed of metal plating or plastic filled with carbon fibers, respectively.

As yet a further example variation, terminal subassemblies 240 and 250 were each illustrated with one row of contact portions. Techniques as described herein may be used in connection with double density connectors, in which terminal subassemblies may have two or more rows of contact portions. Additionally, techniques as described herein may be used in conjunction with terminal subassemblies with more than two rows of contact portions, for example 3 rows, 4 rows, 5 rows or greater than 5 rows of contact portions.

Techniques for making low loss, high frequency connections were described for making connections between an I/O connector and components in an electronic system remote from the I/O connector. Techniques as described herein may be used for any of multiple types of components, including microprocessors, graphics processors, FPGAs or ASICS, any of which may receive and/or transmit data at high speeds.

Additionally, embodiments shown herein are configured for mating to a single density paddle card, however the techniques described herein may be applied to connectors configured for mating with multi-density paddle cards.

Moreover, a midboard cable termination assembly other than as pictured herein may be used in conjunction with an I/O connector configured for making cabled connections. More generally, the cables extending from an I/O connector may be terminated in other ways, including directly to a printed circuit board, device package, to other electrical connectors or other structures.

Further, a system configuration was described in which an I/O connector may receive a plug terminating an active optical cable. Techniques as described herein are not limited to use with active optical cables, and may be used, for example, with connectors that receive active or passive plugs terminating copper cables.

Terms signifying direction, such as “upwards” and “downwards,” were used in connection with some embodiments. These terms were used to signify direction based on the orientation of components illustrated or connection to another component, such as a surface of a printed circuit board to which a termination assembly is mounted. It should be understood that electronic components may be used in any suitable orientation. Accordingly, terms of direction should be understood to be relative, rather than fixed to a coordinate system perceived as unchanging, such as the earth's surface.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, circuits and modules depicted and described may be reordered in any order, and signals may be provided to enable reordering accordingly.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. An electrical connector configured for mounting to a printed circuit board and comprising a first mating interface configured for mating the electrical connector to a mating component, the electrical connector comprising:
a first subassembly comprising:
a first housing, and
a first plurality of conductive elements held by the first housing, each of the first plurality of conductive elements comprising a mating contact portion and a tail configured for connection to a printed circuit board; and
a second subassembly, configured to be separably coupled to the first subassembly at a second mating interface, wherein the second subassembly comprises:
a second housing; and
a second plurality of conductive elements supported by the second housing, the second plurality of conductive elements comprising conductive elements of a first type and conductive elements of a second type, wherein:
each of the second plurality of conductive elements comprises a contact portion exposed at the first mating interface;
each of the first type of conductive elements of the second plurality of conductive elements comprises a mating end portion configured to mate with a mating contact portion of a respective conductive element of the first plurality of conductive elements at the second mating interface; and
each of the second type of conductive elements of the second plurality of conductive elements comprises a tail portion configured for cable termination.

2. The electrical connector of claim 1, further comprising:
a member configured to hold the first subassembly relative to the second subassembly such that the mating contact portions of the first plurality of conductive elements are coupled to the mating end portions of the first type of conductive elements of the second plurality of conductive elements.

3. The electrical connector of claim 2, wherein:
the second housing comprises a receptacle housing comprising a cavity defining the first mating interface;
the second plurality of conductive elements are disposed at least in part within the receptacle housing; and
the member configured to hold the first subassembly relative to the second subassembly is a cage surrounding at least a portion of the first subassembly and a portion of the receptacle housing and comprising a channel configured to guide a plug for engagement with the first mating interface of the electrical connector.

4. The electrical connector of claim 1, wherein:
the second subassembly comprises a plurality of terminal subassemblies, each of the plurality of terminal subassemblies comprising a housing; and
the second housing comprises the housings of the plurality of terminal subassemblies.

5. The electrical connector of claim 4, wherein:
the plurality of terminal subassemblies comprises a first terminal subassembly and a second terminal subassembly; and
the housing of the first terminal subassembly comprises a first insulative portion coupled to intermediate portions of at least some conductive elements of the second plurality of conductive elements.

6. The electrical connector of claim 5, wherein the electrical connector further comprises:
a plurality of cables, each of the plurality of cables terminated to the tail portions of conductive elements of the second type of the first terminal subassembly; and
the housings of the plurality of terminal subassemblies comprise a strain relief portion mechanically coupled to a portion of each of the plurality of cables.

7. The electrical connector of claim 1, wherein:
the second housing comprises a slot; and
at least a portion of the first subassembly is disposed in the slot of the second housing.

8. The electrical connector of claim 7, wherein:
the slot is elongated between a first end, facing the mating interface, and a second end; and
the slot of the second housing is open at the first end.

9. The electrical connector of claim 1, wherein:
the mating contact portions of the first plurality of conductive elements or the mating end portions of the first type conductive elements of the second plurality of conductive elements are compliant beams such that the mating end portions of the first type of conductive elements of the second plurality of conductive elements are mated to mating contact portions of the respective conductive element of the first plurality of conductive elements through a pressure contact.

10. The electrical connector of claim 1, wherein:
the mating end portions of the first type of the second plurality of conductive elements are configured to wipe over the mating contact portions of the first plurality conductive elements when the first subassembly and second subassembly are assembled.

11. The electrical connector of claim 1, wherein the tail of each of the first plurality of conductive elements is configured for a press fit connection.

12. The electrical connector of claim 1, wherein the first subassembly and the second subassembly are configured to nest.

13. The electrical connector of claim 1, wherein:
the electrical connector is in combination with a printed circuit board and a plurality of cables;
the first plurality of conductive elements is mounted to the printed circuit board at a first location; and
cables of the plurality of cables are connected to the ends of the second type of conductive elements configured for a cable termination and are electrically coupled to the printed circuit board at a second location, different from the first location.

14. An electrical connector, comprising:
a first subassembly comprising:
a first housing, and
a first plurality of conductive elements held by the first housing and configured to be mounted to a printed circuit board; and
a second subassembly, configured to be separably coupled to the first subassembly, wherein the second subassembly comprises:
a second housing; and
a second plurality of conductive elements supported by the second housing, having conductive elements of a first type and a second type;
wherein conductive elements of the first type have mating end portions configured for a separable electrical connection to the first plurality of conductive elements and conductive elements of the second type have tail portions configured for a cable termination.

15. The electrical connector of claim 14, further comprising:
a member electrically connecting the first type of conductive elements to the first plurality of conductive elements.

16. The electrical connector of claim 14, wherein:
the second subassembly comprises a plurality of terminal subassemblies comprising at least a first and a second terminal subassembly;
each of the plurality of terminal subassemblies comprises an insulative portion coupled to intermediate portions of at least some conductive elements of the second plurality of conductive elements;
the second housing comprises the insulative portions of the plurality of terminal subassemblies and a connector housing; and
the plurality of terminal subassemblies are disposed, at least in part, in the connector housing.

17. The electrical connector of claim 16, wherein:
the electrical connector comprises a planar mounting interface configured for mounting to a surface of a printed circuit board; and
the conductive elements coupled to the insulative portions are positioned in a plurality of rows, the rows extending in a direction parallel to a plane of the mounting interface.

18. The electrical connector of claim 14, wherein:
the electrical connector is in combination with a plurality of cables, each of the plurality of cables terminated to the tail portion of a conductive element of the second type of the first terminal subassembly.

19. The electrical connector of claim 14, wherein the electrical connector is in combination with a cage configured to surround at least a portion of the first subassembly and a portion of the second subassembly, and wherein the cage comprises:
a floor comprising an opening configured to receive the first subassembly;
a channel configured to guide a plug for engagement with a mating interface of the electrical connector; and
pressfits configured for attachment to the printed circuit board.

20. The electrical connector of claim 14, wherein:
the first plurality of conductive elements comprises pads; and
the mating end portions of the conductive elements of the first type of the second plurality of conductive elements are configured to wipe along the pad portions of the first plurality conductive elements as the second subassembly is separably coupled to the first subassembly.

21. The electrical connector of claim 14, wherein the first subassembly is nested within the second subassembly.

22. The electrical connector of claim 14, wherein:
the electrical connector is in combination with a printed circuit board and a plurality of cables;
the first plurality of conductive elements is mounted to the printed circuit board at a first location; and
the plurality of cables connected to the tail portions of the second type of conductive element and are coupled to the printed circuit board at a second location, different from the first location.

23. A method of assembling an electronic device, the method comprising:
mounting a first subassembly of an electrical connector to a printed circuit board at a first location, the first subassembly comprising a plurality of electrical conductors each comprising a tail, the mounting comprising mechanically and electrically connecting the tails of the plurality of electrical conductors to the printed circuit board; and
coupling a second subassembly to the first subassembly,
wherein:
coupling the second subassembly to the first subassembly comprises electrically connecting a plurality of conductive elements of a first type in the second subassembly to the first plurality of electrical conductors of the first subassembly; and
connecting a plurality of cables of the second subassembly to the printed circuit board at a second location, different than the first location.

24. The method of claim 23, wherein:
the second subassembly comprises a mating interface of the electrical connector.

25. The method of claim 24, further comprising:
prior to coupling the second subassembly to the first subassembly, terminating the plurality of cables to a plurality of conductive elements of a second type in the second subassembly.

26. The method of claim 25, further comprising:
mounting a cage to the printed circuit board at the first location, wherein the cage covers at least a portion of the first subassembly, and the first subassembly is fixed within an opening in a bottom wall of a cage, wherein:
mounting the first subassembly to the printed circuit board and mounting the cage to the printed circuit board comprises pressing the cage and the first subassembly onto the printed circuit board; and
coupling the second subassembly to the first subassembly comprises inserting the second subassembly into a channel of the cage and engaging at least one engagement feature of the second subassembly with at least one engagement feature of the cage.

27. The method of claim 26, further comprising:
disengaging the at least one engagement feature of the second subassembly from the at least one engagement feature of the cage;
decoupling the second subassembly from the first subassembly;
removing the second subassembly from the channel of the cage such that the first subassembly and the second subassembly are decoupled; and
disconnecting the cables from the printed circuit board.

28. The method of claim 26, further comprising:
coupling a new second subassembly with the first subassembly, such that a second plurality of conductive elements of a first type of the new second subassembly contact the conductive elements of the plurality of conductive elements of the first subassembly; and
connecting a second plurality of cables to the printed circuit board at the second location.
